(19) United States
(12) Patent Application Publication
(10) Pub. No.: US 2026/0044688 A1
(43) Pub. Date: Feb. 12, 2026

(54) METHOD AND SYSTEM FOR TRANSLATING CONTENT

(71) Applicant: NAVER WEBTOON LTD., Seongnam-si (KR)

(72) Inventors: Jae Han YOON, Seongnam-si (KR); Yu Jin HONG, Seongnam-si (KR); Ji Seon SIM, Seongnam-si (KR); Jun Eyoun MOON, Seongnam-si (KR); Jae Hyuk JANG, Seongnam-si (KR); Wan Been JOO, Seongnam-si (KR); Joo A CHA, Seongnam-si (KR); Ju Yul PARK, Seongnam-si (KR); Yu Jin CHUNG, Seongnam-si (KR); Young Sub CHOI, Seongnam-si (KR)

(21) Appl. No.: 18/982,677

(22) Filed: Dec. 16, 2024

(30) Foreign Application Priority Data
Aug. 6, 2024 (KR) 10-2024-0104875

(51) Int. Cl. G06F 40/58; G06F 3/0482; G06F 3/0483

(52) U.S. Cl. CPC G06F 40/58; G06F 3/0482; G06F 3/0483

(57) ABSTRACT

A method of translating content includes receiving an image file of a translation target related to an episode of content created based on a language of a first country; and providing a translation editor for the image file so that a translated episode of the episode based on a language of a second country, different from the first country, is generated. The translation editor may provide an input window for receiving a translated language in the language of the second country for the image file as input, and a translation support tool having a plurality of translation support function tabs that recommend the translated language, each interworking with data established based on different databases.

### CROSS REFERENCE TO RELATED APPLICATION

The present application claims priority to Korean Patent Application No. 10-2024-0104875, filed on Aug. 6, 2024, the entire contents of which are incorporated herein for all purposes by this reference.

### BACKGROUND OF THE INVENTION

### Field of the Invention

The present invention relates to a method of translating content and a system for supporting the same.

### Description of the Related Art

As technology advances, the use of digital devices increase. In particular, electronic devices (e.g., smartphone, tablet PC, etc.) are equipped with various functions including communication functions such as phone calls or text messages, as well as surfing the web, listening to music, and watching videos using the Internet.

With the popularization of electronic devices, consumption of contents provided through the electronic devices such as PCs or mobile devices is rapidly increasing. As an example, there is webcomics. The webcomic is a comic serialized and distributed through an Internet communication network.

As the consumption of these webcomics continues to increase, various service providers (or webcomic-related service providers) are developing various services to secure users (or consumers, subscribers) who can use the services steadily.

For example, Korean Laid-Open Patent No. 10-2018-0119005 (a webtoon providing method using a sharing function) discloses a method of allowing a user owning a webcomic online to share the webcomic with other users. Those other users can read part of the webcomic and decide whether to make a purchase, thereby enabling users to purchase webcomics containing content of their preference.

Such webcomics go beyond being created by authors and provided as a service in their respective countries, and are now being serviced globally. Therefore, it is essential that they are translated into various languages of different countries. As described above, in order to enhance consumer purchase intent for content on a global scale, customized translation for each country is necessary. However, a systematic translation process for webcomics has not yet been established.

### SUMMARY OF THE INVENTION

The present invention relates to a method and a system for performing content translation, thereby enabling users from a plurality of countries to continuously use the content.

Further, the present invention relates to a method of translating content, which is capable of providing a user environment optimized for translation tasks to content translation performer, and to a system that supports the same.

Particularly, the present invention relates to a method and a system for translating content that is capable of providing a new form of translation support tool that is able to support a translation task.

To achieve the aforementioned objects, there is provided a method of translating content, according to the present invention. The method may include receiving an image file of a translation target related to an episode of content created based on a language of a first country; and providing a translation editor for the image file so that a translated episode of the episode based on a language of a second country, different from the first country, is generated, wherein the translation editor may provide an input window for receiving a translated language in the language of the second country for the image file as input, and a translation support tool having a plurality of translation support function tabs that recommend the translated language, each interworking with data established based on different databases.

There is provided a system for translating content, according to the present invention. The system may include a management server configured to register an image file of a translation target for an episode of content created based on a language of a first country, and a translation server configured to receive the image file of the translation target, in which the translation server may provide a translation editor for the image file so that a translated episode of the episode based on a language of a second country, different from the first country, is generated, and the translation editor may provide an input window for receiving a translated language in the language of the second country for the image file as input, and a translation support tool having a plurality of translation support function tabs that recommend the translated language, each interworking with data established based on different databases.

There is provided a program stored on a non-transitory computer-readable recording medium, and executed by one or more processors in an electronic device, according to the present invention. The program may include instructions to allow the electronic device to perform receiving an image file of a translation target related to an episode of content created based on a language of a first country, and providing a translation editor for the image file so that a translated episode of the episode based on a language of a second country, different from the first country, is generated, in which the translation editor may provide an input window for receiving a translated language in the language of the second country for the image file as input, and a translation support tool having a plurality of translation support function tabs that recommend the translated language, each interworking with data established based on different databases.

The method and the system for performing content translation according to the present invention provides a new form of translation editor and review editor, thereby implementing a translation environment in which translators, reviewers, and others can perform translations more accurately and efficiently.

Further, the method and the system for translating content according to the present invention may provide a translation support tool that has a plurality of translation support function tabs, each interworking with data established based on different databases to recommend the translated language. The translation representative can conveniently access the information needed for the translation task and translate more quickly and accurately using the translation support tool.

In addition, according to the present invention, translation memory or glossary can be provided in a user-customized manner, thereby improving the efficiency and accuracy of translation task.

### BRIEF DESCRIPTION OF THE DRAWINGS

FIG. 1 is a diagram for describing a system for performing content translation according to the present invention.

FIGS. 2A and 2B are flowcharts for describing a method of performing content translation according to the present invention.

FIGS. 3A and 3B are flowcharts for describing data flow according to the method of performing content translation of the present invention.

FIGS. 4A-4D are drawings for describing an operator account and a manager account according to the present invention.

FIG. 5 is a flowchart for describing a method of translating content in the system for performing content translation according to the present invention.

FIG. 6 is a diagram for describing episodes of content provided in the present invention.

FIG. 7A and FIG. 7B are drawings for describing a translation editor provided in the present invention.

FIGS. 8A-8C and FIGS. 9A-9C are diagrams for describing a translation support tool provided in the present invention.

FIG. 10 is a diagram for describing a translation file according to the present invention.

FIG. 11 is a diagram for describing a method of reviewing a lettered file in the present invention.

FIG. 12 is a table illustrating a method of calculating the number of words to be translated according to the present invention.

### DETAILED DESCRIPTION OF THE INVENTION

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The terms “module”, “unit”, “part”, and “portion” used to describe constituent elements in the following description are used together or interchangeably in order to facilitate the description, but the terms themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be understood that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

The present invention relates to a method of operating content translation and a system therefor, which may provide a function interface necessary for translation, lettering, and review tasks of content, in linkage with content provision services, as well as a communication tool (e.g., Inbox, Message) between task operators.

The types of content to which the present invention may be applied may be highly diverse. For example, at least one type of content, such as webcomics, web novels, music, e-books, videos, or images, may correspond to the content provided in the present invention.

Hereinafter, for convenience of description, the content corresponding to a webcomic will be used as an example. Here, a webcomic refers to a combination of “web” and “comics,” meaning cartoons or comics provided through an Internet communication network.

Such content may be composed of a plurality of sub-content. A plurality of sub-content may make up a series of the content.

Here, a series may refer to sequentially planned works or content.

In the present specification, to avoid confusion between “content” and “sub-content,” the term “sub-content” will be referred to as “episode.”

In the present invention, “using (consuming or viewing) content” may be understood as using (consuming or viewing) an episode.

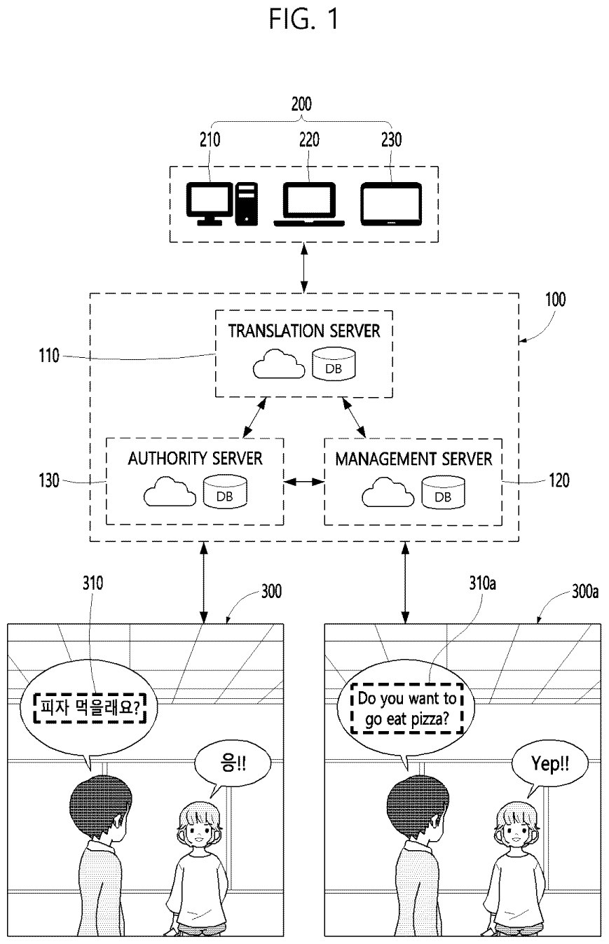

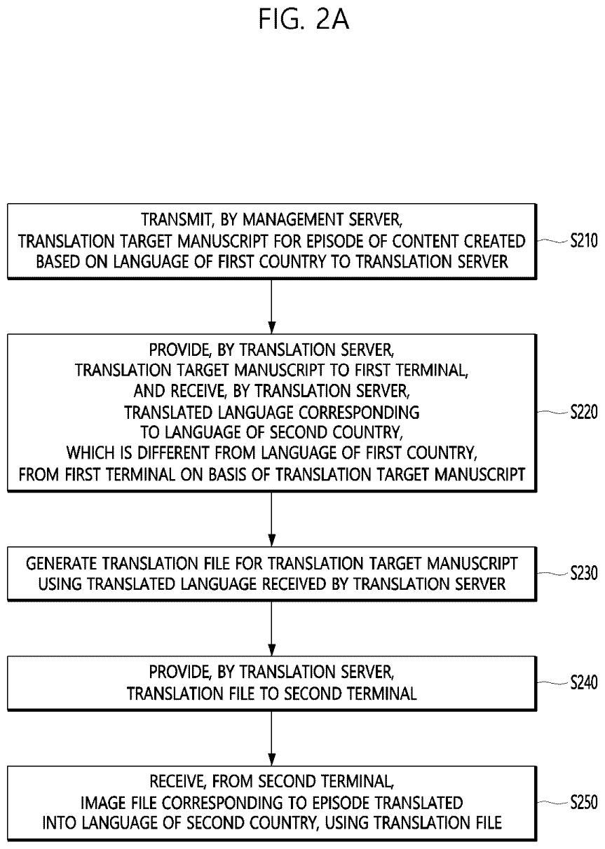

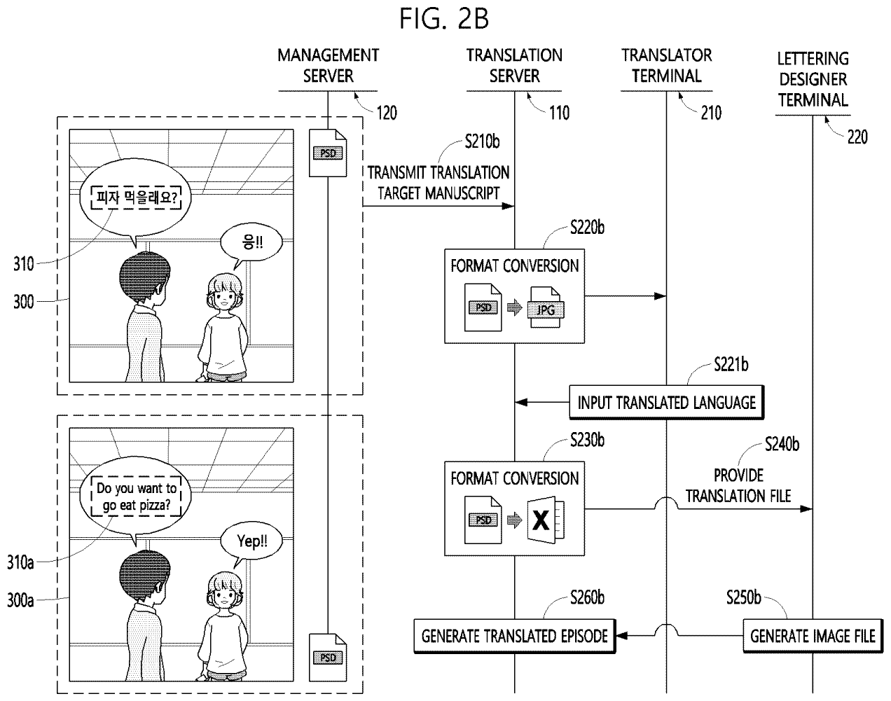

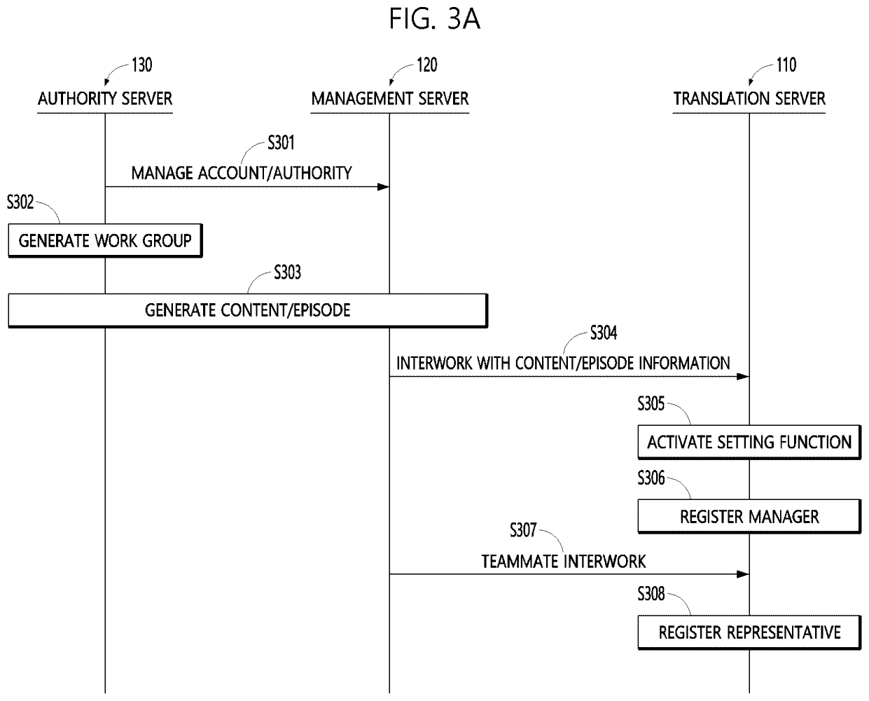

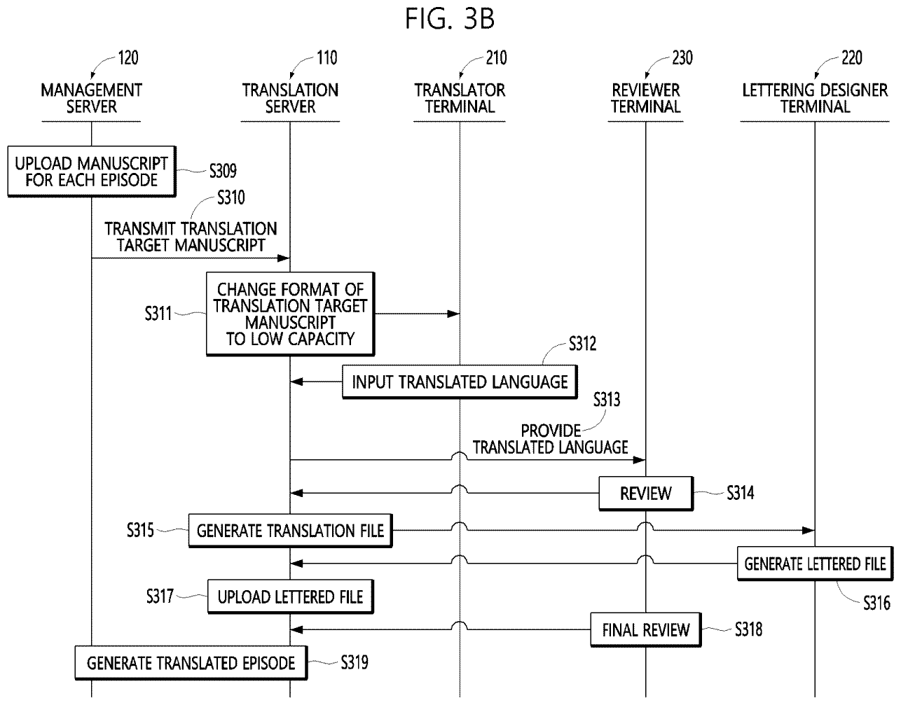

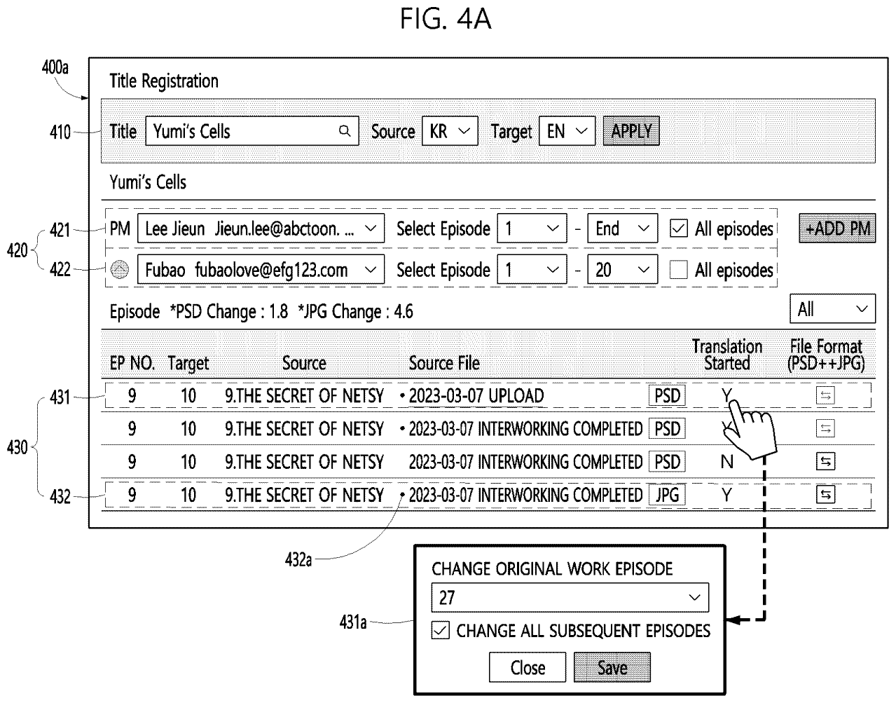

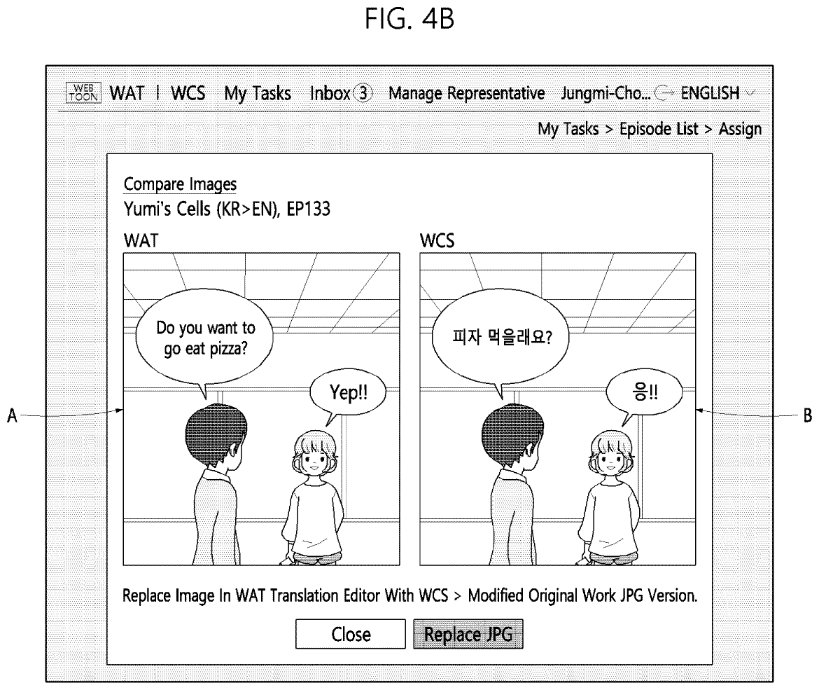

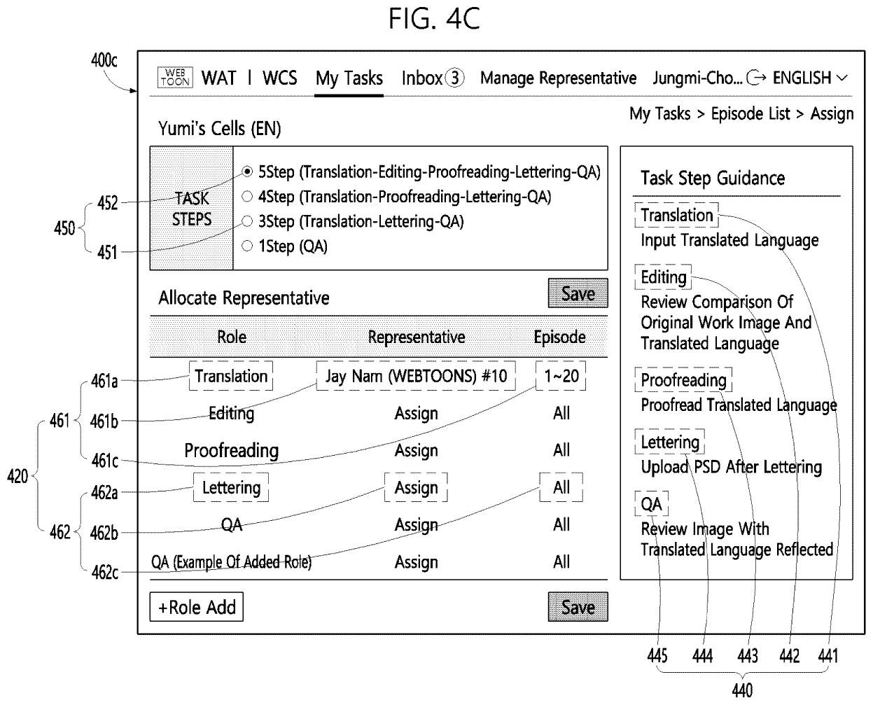

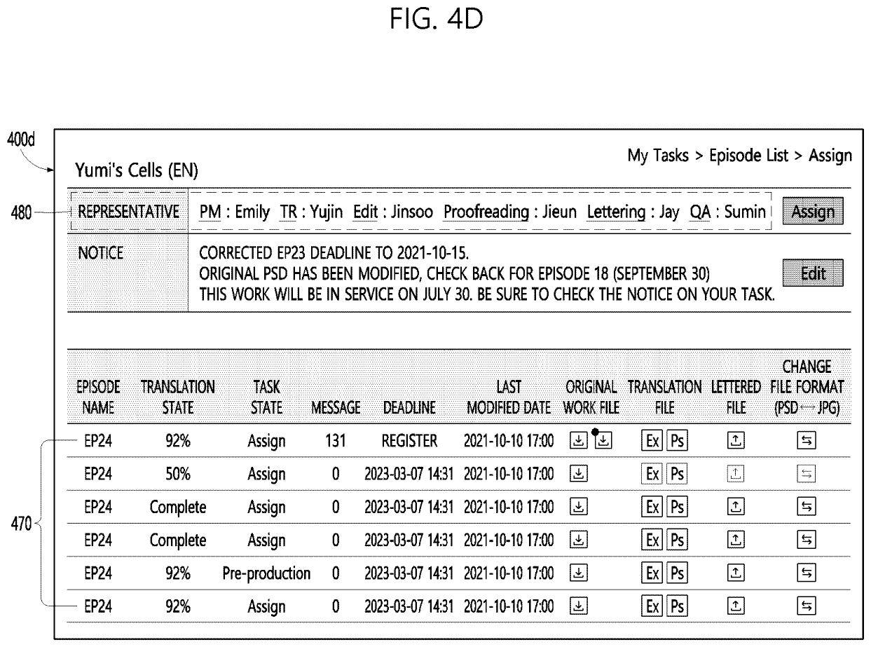

Hereinafter, a method of translating content will be specifically described with reference to the accompanying drawings. FIG. 1 is a diagram for describing a system 1 for performing content translation according to the present invention. FIGS. 2A and 2B are flowcharts for describing a method of operating content translation according to the present invention, FIGS. 3A and 3B are flowcharts for describing data flow according to the method of performing content translation of the present invention, and FIGS. 4A-4D are diagrams for describing an operator account and a manager account according to the present invention.

As illustrated in FIG. 1, a system 100 for performing content translation may translate an episode 300 of content, which has been created based on the language of a first country (e.g., Korean, “ [symbol] ?”, 310), into the language of a second country that is different from the first country (e.g., English, “Do you want to go eat pizza?”, 310a).

Here, the “language of a first country” refers to a translation target language (original work language or source language), and the “language of a second country” may refer to the language of another country into which the language of the first country is translated (or target language).

The system 100 for performing content translation includes a task of translating the language of a first country (e.g., Korean, 310) included in a content episode into the language of a second country (e.g., English, 310a), as well as tasks of reviewing and lettering the translated language. In the present specification, this will be referred to as a “translation process” or a “translation review process.” English is merely an example for translation purposes, and the language of the second country may be any one of various languages, such as Japanese, Chinese, Spanish, Arabic, Indonesian, Thai, and others. Further, while the present invention provides an example of translating Korean into another language, it is also possible to translate another language into Korean or to translate between languages of different countries.

To provide such a translation process, the system 100 may include at least one of an authority server 130, a management server 120, and a translation server 110. The authority server 130, management server 120, and translation server 110 may be configured to transmit and receive various information related to content provision or content translation operations through wired or wireless communication. The transmission and reception of information may be performed by a communication unit included in each of the servers 110, 120, 130.

Here, each of the authority server 130, the management server 120, and the translation server 110 may be a computer system having at least one processor for performing various functions including providing information or services through a network. The servers 110, 120, 130 may be configured to exchange various information or data with other servers or user terminals. The authority server 130 may be configured to perform a role of managing authority for at least one of user accounts or content registered in the management server 120. The authority server 130 may receive a request for assigning authority or may assign authority on the basis of a specific condition being satisfied by a user account registered in the management server 120.

The authority server 130 may be configured to perform a role of managing authority for at least one of user accounts or content registered in the management server 120. The authority server 130 may receive a request for assigning authority or may assign authority on the basis of a specific condition being satisfied by a user account registered in the management server 120.

For example, the authority server 130 may assign an operator account, which holds the authority to operate the translation process, to a specific user on the basis of an operator account assignment request. As another example, the authority server 130 may register a specific user account, which is registered in the management server 120, as a manager who holds the authority to designate a representative for the translation process (e.g., translator, lettering designer, reviewer, etc.), on the basis of a request from an operator account.

The management server 120 may be configured to perform roles related to content provision and the management of content translation operations. The management server 120 may store original content (or original work content) received from an author, and on the basis of the original content, the management server 120 may provide the original content to the translation server 110 to carry out the translation process. In this case, the management server 120 manages user accounts and authority related to translation and performs the function of providing a source file of a translation target, as original content, to the translation server 110.

The system 100 may transform the file format of content episodes in various ways in the translation process and provide them to representatives.

For example, when an original episode image file received from the author is a high-capacity first type of file, in the present invention, the high-capacity file may be converted into a low-capacity second type of file and provided to the translation representative. As another example, when the original episode image file is the low-capacity second type of file, it is also possible to convert the low-capacity second type of file into the high-capacity first type of file.

The high-capacity first type of file may be, for example, a photoshop document (PSD) file, a Clip file (clip studio file), etc., while the low-capacity second type of file may be, for example, a JPG or PNG file, etc. However, the present invention is not limited to the examples of the first type and the second type of file, and they may be transformed into various forms. For example, as technology advances, other files may be applied to the high-capacity files presented as examples, in addition to PSD files or Clip files. In addition, as the low-capacity file, a different file may be applied as needed.

Further, to allow the lettering representative to intuitively recognize a translated language and a lettering task position, a third type of file in which a first language is matched with the translated language of the first language may be provided to a lettering designer. The third type of file may be, for example, a document file. The document file may be, for example, an Excel file or a Word file, and may be transformed into various forms. Hereinafter, a case where the third type of file is an Excel file will be described as an example.

The management server 120 may manage various types of files generated in the translation process by mapping (or matching) the various types of files to each other, with respect to original content episodes. Such mapped information may be used to review whether the translation is correct by comparing a translated output with the original content.

The translation server 110 may perform the role of providing a customized environment to each representative so that the translation process, from the setting of representatives of the translation process to translation, lettering, and review tasks, may be performed.

The translation server 110 may set task steps (or task processes) and task representatives for the translation process of a specific episode through the designation by an operator account or a manager account.

In the present invention, tasks included in the translation process may include at least one of i) translation (or inputting translated language), ii) an editing review in which a translated language is modified and input, iii) a proofreading review, which uses messages on the translated language to provide feedback, iv) lettering, which changes the characters of an original content episode into the translated language, or v) an image review (lettered file review, final review, or QA review), which verifies an image reflecting the translated language.

In the operator account or manager account, representatives for the translation process of a content episode may be designated on a task-by-task basis (a task-unit basis) (e.g., translation task—‘representative A’, lettering task—‘representative B’), while deadlines may be designated on an episode basis.

The translation server 110 may provide a translation editor (a translation tool that allows each task included in the translation process to proceed) to a terminal 200 of a translation process representative (or representative account or user account of the representative). Such a translation editor may provide translation support tools (e.g., memory, glossary) as well as features (image review, file format conversion, inbox messages, feedback, image comparison function, and the uploading of translated episodes after the completion of lettering tasks).

The system 100 for performing content translation according to the present invention may be connected to at least one terminal 200 via wired or wireless communication. As illustrated in FIG. 1, the terminal 200 refers to an electronic device, and may be a smartphone, notebook computer, laptop computer, slate PC, tablet PC, ultrabook, desktop computer, and the like, without limitation on types. The service provided in the present invention may be used through the terminal 200 logged in with a user account registered on the management server 120. For example, a translator responsible for the translation of an episode may be provided with a translation editor through a terminal 210 (which also may be referred to as a translator terminal) logged in with his or her user account, and may proceed with a task of translating the language of a first country included in the episode into the language of a second country using various functions provided in the translation editor. As another example, a lettering representative (lettering designer), responsible for lettering (sketching, drawing, or designing) a translated language into an episode, may be provided with a translation file using a terminal 220 (which also may be referred to as a lettering designer terminal) logged in with his or her user account. Accordingly, in the present invention, “user,” “representative (e.g., translator),” “user account (e.g., translator account),” and “terminal (e.g., translator terminal)” may be used interchangeably.

As illustrated in FIG. 2A, a process of transmitting a translation target manuscript for an episode of content created based on the language of the first country from the management server to the translation server may proceed (S210).

As described above, the original content (or original work content) may exist to be stored in the management server 120, and on the basis of at least one episode of the original content being specified as a translation target, the management server 120 may provide a file of the specified episode as a translation target manuscript to the translation server 110.

In this case, the management server 120 may transmit a first type of file (e.g., PSD, Clip, etc.) including a plurality of layers to the translation server 110 (S210b, see FIG. 2B).

The first type of file may have layers separated by different elements (e.g., background, character, text, speech bubbles, etc.), and the management server 120 may provide the first type of file to the translation server 110 so that changing the language of the first country to the language of the second country may be done more easily.

In the present invention, a process in which the translation server provides a translation target manuscript to a first terminal and receives, from the first terminal, a translated language corresponding to the language of a second country, which is different from the language of a first country, on the basis of the translation target manuscript, may proceed (S220, see FIG. 2A).

The translation server 110 may identify a translation representative of a translation target manuscript and provide the translation target manuscript to the first terminal 210 (translator terminal) logged in with a translation representative account.

Matching information on translation process representatives (e.g., translation representative, lettering design representative, etc.) for a specific episode may exist in the database (DB) of the translation server 110, A representative may be designated by a manager, and the translation server 110 may refer to the database (DB) to provide information necessary for tasks to representatives corresponding to the process in which the translation is being carried out. The details regarding the designation of a representative by a manager will be described below.

The translation server 110 may convert the first type of translation target manuscript into a second type of file, which is different from the first type, and provide the second type of file to the first terminal 210 (translator terminal) (S220b, see FIG. 2B).

As such an example, the translation server 110 is configured to allow a file format to be changed in the operator account and manager account, depending on a file format type obtainable from a content writer or on a file format type that is more suitable for translation. Hereinafter, an example will be given of a process of converting a high-capacity file of a first type into a low-capacity file of a second type. However, this is merely an example, and it is also possible to convert a low-capacity file into a high-capacity file as needed. In such a case, the management server transmits the second type of translation target manuscript to the translation server, and the translation server may convert the second type of translation target manuscript into the first type of file, which is different from the second type, and provide the converted first type of file to the first terminal.

Additionally, as described above, the first type of file may be, for example, a photoshop document (PSD) file, a Clip file (clip studio file), etc., and this may be substituted with various other types of files. In addition, the low-capacity second type of file may be, for example, a JPG or PNG file, but this may also be substituted with various other types of files.

The first type of file (e.g., PSD, Clip, etc.) is composed of a plurality of layers, which makes it easy to be modified, but may be a high-capacity file. Since the translation representative is not responsible for carrying out modification tasks on the translation target manuscript, the high-capacity first type of file is not needed. Therefore, the translation server 110 may convert the translation target manuscript from the first type of file into the second type of file with a smaller capacity than the first type, and provide the converted second type of file to the first terminal 210 (translator terminal) for efficient data communication.

The translation server 110 may provide the first terminal 210 (translator terminal) with a translation editor that includes the translation target manuscript converted into the second type of file. As described above, the translation editor is an interface for an efficient task environment for representatives, and further details will be described below.

On the first terminal 210 (translator terminal), the translation target manuscript converted into the second type of file is displayed, and a translated language (e.g., “Do you want to go eat pizza?”, 310a) corresponding to the language of the first country included in the translation target manuscript (e.g., “ [symbol] ?”, 310) may be input. The translation server 110 may receive the translated language on the basis of the translated language being input into the first terminal 210 (translator terminal) (S221b, see FIG. 2B).

Further, in the present invention, a process of generating a translation file for the translation target manuscript using the translated language received by the translation server may proceed (S230, see FIG. 2A).

The translation server 110 may generate a translation file for the translation target manuscript using the translated language received from the first terminal 210 (translator terminal).

In the present invention, the “translation file” may refer to a file provided to the lettering design representative responsible for a lettering task of the translated language.

A lettering designer, on the basis of the translation file, may be responsible for a task of changing the language of the first country to the language of the second country on a character layer among the plurality of layers in the translation target manuscript. The lettering designer needs to input (create, design, or sketch) the translated language in an area where the language of the first country was positioned, and it is very important for the lettering designer to intuitively recognize matching relationship between the language of the first country and the language of the second country, which is the translated language.

The translation server 110 may generate a translation file in which the language of the first country and the translated language of the second country are each matched, so that the lettering designer may intuitively recognize the relationship between the language of the first country and the translated language corresponding to the language of the first country (see FIG. 4D).

In this case, the translation server 110 may generate the translation file as at least one of a first type of file (e.g., PSD, Clip, etc.) or a third type of file (e.g., Excel) (S230b, see FIG. 2B). That is, the translation server 110 may set different formats of image files for the first terminal 210 (translator terminal) and the second terminal 220 (lettering designer terminal), and provide the translation target manuscript accordingly. Therefore, representatives may be provided with files in a format optimized for their tasks.

Further, in the present invention, the translation server may provide the translation file to the second terminal (S240, see FIG. 2A).

The translation server 110 may identify a responsible lettering designer for the translation target manuscript by referring to the database (DB), on the basis of the process in which the translation is being carried out corresponding to a lettering process. The translation server 110 may transmit the translation file to the second terminal 220 (lettering designer terminal) logged in with the account of the responsible lettering designer. For example, the translation server 110 may provide both the first type of translation file (e.g., PSD, Clip, etc.) and the third type of translation file (e.g., Excel) to the second terminal 220 (lettering designer terminal) (S240b, see FIG. 2B), and the lettering designer may proceed with the lettering task by selecting a desired type of translation file between the first type and the third type.

The translation process further includes a “review” task process, and a review task may further include an editing review and a proofreading review performed between the translation task and the lettering task, as well as an image review performed after the lettering task. Further details regarding the entire process, including the review process, will be described below.

A process of receiving an image file corresponding to the episode, translated into the language of the second country using the translation file, from the second terminal may proceed (S250, see FIG. 2).

The translation server 110 may provide the second terminal 220 (lettering designer terminal) with the translation file and the first type of translation target manuscript file.

In the second terminal 220 (lettering designer terminal), on the basis of the translation file, the task of changing the characters of the language of the first country included in a character layer among the plurality of layers that make up the translation target manuscript file to the translated language, which is the language of the second country may be carried out. In the second terminal 220 (lettering designer terminal), an image file including the language of the second country may be generated (S250b), and the translation server 110 may receive the image file.

In the image file received from the lettering designer terminal 220, the characters of the episode has been changed to the language of the second country, which is different from the first country, and in the present invention, this may be referred to as a “lettered file.” In the translation server 110, a translated episode for the content episode may be generated using the lettered file (S260b, see FIG. 2B).

The system 100 may operate a translation platform in linkage with the authority server 130, management server 120, and translation server 110 to specify content works that require translation, set translation, lettering, and review representatives for the specified content, and ensure that tasks are carried out by the representatives according to the order of the tasks. Hereinafter, the entire translation process that proceeds in the present invention, from specifying the work to reviewing, will be described.

As illustrated in FIG. 3A, the authority server 130 may manage user accounts and authorities (S301). The authority server 130 may assign an operator account, which holds the operation authority for the translation process, to a specific user on the basis of an operator account assignment request.

In the present invention, an “operator (or operator account)” may have authority over at least one of multiple designating managers, managing the translation target manuscript, managing translation process representatives, and managing translation support tools (e.g., glossary).

In the authority server 130, a work group may be generated (S302, see FIG. 3A). Further, on the basis of the work group being generated in the authority server 130, at least one of the authority server 130 or the management server 120 may generate content and episodes based on the work group (S303, see FIG. 3A). Work groups, content, and episodes may be generated in sequence, and on the basis of the content and episodes being generated, information on the content and episodes may be linked to the translation server 110 (S304, see FIG. 3A).

Information on the content and episodes may vary widely. As described above, the content may be made up of a plurality of episodes, and episode information according to a predefined order (e.g., upload order) may exist to be matched with the plurality of episodes. For example, the plurality of episodes that make up a specific content titled “Yuna's Cells” may have episode information matched according to the upload order, such as Episode 1 (ep. 1), Episode 2 (ep. 2), and Episode 3 (ep. 3). Various types of information, such as content (e.g., content title information), episodes making up the content (e.g., episode files), and episode numbers, are matched with each other. In the management server 120 and translation server 110, the information on the content and episodes may continuously be linked and updated.

When the content and episodes are generated in the management server 120, a setting function (or title registration function) for registering the translation target content may be activated in the translation server 110 (S305, see FIG. 3A).

As illustrated in FIG. 4A, a service page 400a provided to the operator account may include translation target content and a setting function (or setting function area 410) for setting the types of languages for the first country and the second country for the translation target content. In the translation server 110, through the setting function 410, may receive content title information (e.g., “Yumi's Cells”), information on the type of language for the first country for the content (or original work language code, e.g., KR), and information on the type of language for the second country (or translated work language code, e.g., EN). The translation server 110 may specify translation target content and the first country language and second country language of the translation target content on the basis of the information received through the setting function 410.

The operator account includes the authority to register managers, and in the translation server 110, on the basis of receiving a manager registration request for a specific user account from the operator account, the specific user account may be registered as a manager (S306, see FIG. 3A).

In the present invention, the manager may set task processes and task representatives for the translation process of an episode.

As illustrated in FIG. 4A, the translation server 110 may receive a manager registration request, including information 420 on a specific user account, from the operator account through the service page 400a. The manager registration request may include the manager's name. In addition, in case that the registration of a plurality of managers is requested for a single content, the manager registration request may include information in which the names of each of the plurality of managers are matched with episodes that managers are responsible for.

The translation server 110 may register the task processes and task representatives for the translation process of an episode by setting the task processes and task representatives through either the operator account or the manager account (S308, see FIG. 3A).

Depending on whether the task representative registration is carried out by the operator account or the manager account, the management server 120 and the translation server 110 may proceed with interworking between user accounts (Teammate interwork) (S307, see FIG. 3A).

In the management server 120 and the translation server 110, when a representative registration request is received from the operator account, the requested user may be registered as a representative without the user account interworking process. In contrast, in the management server 120 and the translation server 110, the registration of a representative may proceed only for user accounts that are interworked with the manager account. The management server 120 and the translation server 110 may proceed with the registration of a representative only after interworking with the user account through a Teammate invitation when the manager account and the corresponding user account are not already in an interwork relationship.

Hereinafter, for convenience of description, an example will be provided in which the representative registration is carried out by the manager account, and user account interworking between the manager and the representative has been completed.

In the present invention, the translation process may include at least one of a plurality of task processes, and the translation server 110 may provide a translation task interface corresponding to a task process to the representative terminal of the task process.

As illustrated in FIG. 4A, the translation server 110 may replace the translation target manuscript. When the specific graphic object 432a is selected from the operator account, the translation server 110 may provide the translation target manuscript before modification (existing image A, FIG. 4B), and the translation target manuscript after modification (modified image B, FIG. 4B) to the operator account.

As illustrated in FIG. 4C, the task process (or task step, 440) included in the translation process in the present invention may include at least one of i) translation (or inputting translated language, Translation, 441), ii) an editing review (Editing, 442) in which the translated language is modified and input, iii) a proofreading review (Proofreading, 443) which uses messages on the translated language to provide feedback, iv) lettering (Lettering, 444), which changes the characters of the original content episode into the translated language, or v) an image review (QA, 445), which verifies an image reflecting the translated language.

The translation server 110 may configure the translation process to allow at least one of the plurality of task processes 441 to 445 to be included by the manager account. In the manager account, the translation process may be configured in various ways based on episodes, translation companies and other factors. For example, as illustrated in FIG. 4C, the translation server 110 may configure the process to include only translation, lettering, and image review tasks (Translation—Lettering—QA, 451), or configure the process to include all tasks such as translation, editing review, proofreading review, lettering, and image review (Translation-Editing-Proofreading-Lettering-QA, 452).

The translation server 110 may specify the representative for the task process on the basis of the task process for the episode of the content being specified. The translation server 110 may match the task process (e.g., Translation, 461a), the representative (user account, 461b), and the assigned episode (episodes 1-20, 461c), and store them in the database as a representative dataset 461. The translation server 110 may configure a representative dataset 461 or 462 for each task process of an episode on the basis of the information received from the manager account and store the representative dataset in the database. Further, in the process in which the translation is being carried out for an episode, the translation server 110 may refer to the database to identify the representative for the current task process.

As illustrated in FIG. 4D, the manager account may be provided with a management page 400d related to managing the translation process of an episode. The manager may perform overall task management of the translation process, management for the representatives, and management for deadlines through the management page 400d. To this end, the management page 400d may include a list of translation target content 470 allocated to the manager account, information on each representative for the task processes of the translation process 480, information on the task progress status for each episode, a deadline setting function, functions for registering and modifying notices, and a file upload function, and the like.

In the management server 120, the upload of the translation target manuscripts for each episode of the content may be carried out (S309, see FIG. 3B). For example, the management server 120 may receive a translation target manuscript from a writer account (or writer terminal) that creates the content episodes and upload the translation target manuscript to the database of the management server 120. As another example, the management server 120 may receive a translation target manuscript from a content upload representative account (or representative terminal) and upload the translation target manuscript to the database of the management server 120. The method by which the translation target manuscript is uploaded to the management server 120 may vary.

The management server 120 may transmit the translation target manuscript to the translation server 110 to proceed with the translation process for the translation target manuscript, in linkage with the translation server 110 (S310, see FIG. 3B).

In this case, the translation server 110 may change a file format of the translation target manuscript provided to the first terminal 210 (translator terminal) to a different format type. Such a file format may be converted by the operator account or the manager account as a more suitable type for translation.

For example, the translation server 110 may proceed with the task of converting the translation target manuscript received from the management server 120 into a low-capacity format (S311, see FIG. 3B). However, in this example, converting to a low-capacity format is merely an example, and it is also possible to convert to a high-capacity format as needed, or to make changes regardless of the file capacity on the basis of the translator's opinion or the like.

As described above, content episodes may be configured of a first type of file that includes a plurality of layers. The first type of file may have layers separated by different elements (e.g., background, character, text, speech bubbles, etc.), and the management server 120 may provide the first type of file to the translation server 110 so that changing the language of the first country to the language of the second country may be done more easily. The first type of file is composed of a plurality of layers, which makes it easy to be modified, but may be a high-capacity file. Since the translation representative is not responsible for carrying out modification tasks on the translation target manuscript, the high-capacity first type of file is not needed. Therefore, the translation server 110 may convert the translation target manuscript from the first type of file into the second type of file with a smaller capacity than the first type, and provide the converted second type of file to the first terminal 210 (translator terminal) for efficient data communication.

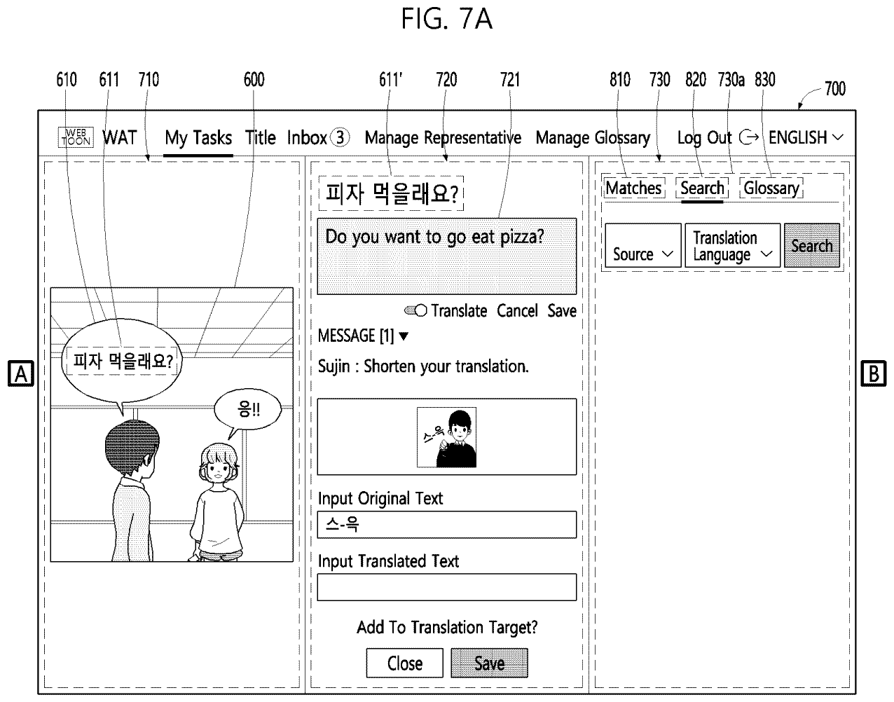

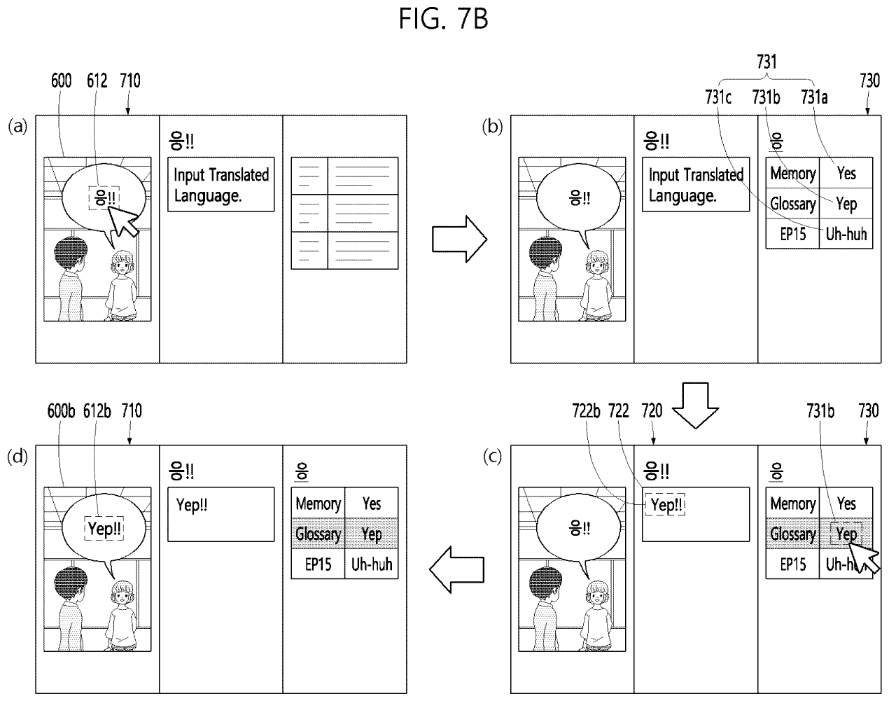

Further, in the translator terminal (first terminal, 210), the translated language corresponding to the language of the first country included in the translation target manuscript may be input (S312, see FIG. 3B). The translation server 110 may provide the translator terminal 210 with a translation editor (see reference numeral “700” in FIG. 7A) that includes a translated language input function. The translation editor 700 may include an input window capable of translated language input.

The translation server 110 may provide the reviewer terminal 230 with a review editor that includes the translated language, so that a review on the translated language may be conducted (S313, see FIG. 3B). More specifically, the translation server 110 may provide the reviewer terminal 230 with an original image corresponding to the translation target manuscript and an image converted into the translated language, so that a review on the translated language received from the terminal of the translation representative may be performed.

As described above, in the present invention, the review process for reviewing the translated language may include an “editing review” that modifies and inputs the translated language, a “proofreading review” that uses messages on the translated language to provide feedback, and an “image review (or QA review)” that needs to perform a review of the lettered file. In the current process, the review task process being described may correspond to an “editing review task” that modifies and inputs the translated language.

The reviewer terminal 230 may compare the original image with the image displaying the translated language and perform an editing review by modifying the translated language (S314, see FIG. 3B).

Further, a proofreading review task, which uses messages on the translated language to deliver feedback to the translation representative, may proceed. A proofreading review representative may be the same user as an editing review representative or a different user. The translation server 110 may transmit a message to the translator terminal on the basis of receiving the message including feedback information on the translated language from a proofreading reviewer terminal. The translation server 110 may display the feedback information received from the proofreading reviewer terminal in one area of the translation editor 700. In this case, the translation server 110 may display the feedback information in the area surrounding the translated language (e.g., “Do you want to go eat pizza?”) that is the subject of the feedback.

The translation server 110 may generate a translation file for the translation target manuscript on the basis of the review of the translated language being completed (S315, see FIG. 3B).

In the present invention, the “translation file” may refer to a file provided to the lettering design representative responsible for a lettering task of the translated language.

The translation server 110 may generate the translation file as at least one of a first type of file or a third type of file. The lettering designer needs to input (create, design, or sketch) the translated language in an area where the language of the first country was positioned, and it is very important for the lettering designer to intuitively recognize matching relationship between the language of the first country and the language of the second country, which is the translated language. Accordingly, in the present invention, the translation file may be generated as a third type of file having a table structure and provided to the lettering designer.

In the second terminal (lettering designer terminal, 220), a lettered file may be generated using the translation file (S316, see FIG. 3B). In the second terminal 220 (lettering designer terminal), on the basis of the translation file, a task may be performed where the characters of the language of the first country, included in the character layer among the plurality of layers that make up the translation target manuscript file, is changed to the translated language, which is the language of the second country. The lettering designer terminal 220 may transmit and upload the lettered file to the translation server 110 (S317, see FIG. 3B). The lettered file may be configured of a first type of file consisting of a plurality of layers.

The translation server 110, upon the upload of the lettered file, may allow a final review of the lettered file to be conducted on the reviewer terminal 230 of the image review representative (S318, see FIG. 3B). Although FIG. 3B illustrates the reviewer terminal for the editing review, proofreading review, and image review (or final review) collectively as “reviewer terminal 230” without distinction, the representatives for the editing review, proofreading review, and image review (or final review) may be different, in which case, the reviewer terminals may also differ.

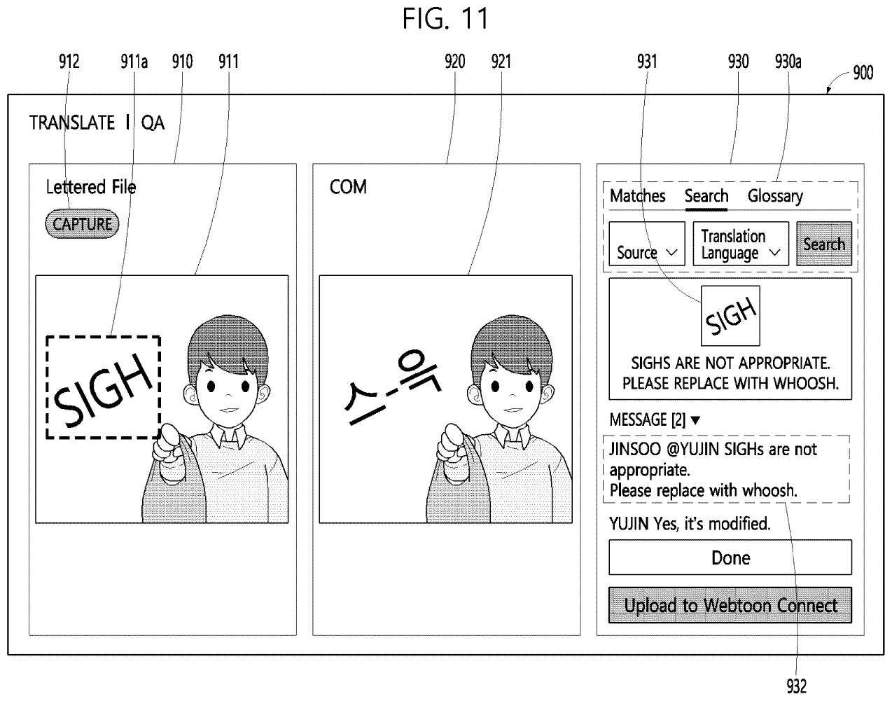

The translation server 110 may provide the image reviewer terminal 230 with a QA editor (see reference numeral “900” in FIG. 11) so that a final review of the translated episode converted into the translated language may be conducted. The QA editor 900 may include an image file of the episode created based on the language of the first country (original image file or image file of the translation target manuscript) and the lettered file converted into the language of the second country (or translated episode image file). The image reviewer terminal 230 may compare the images of the files output in the QA editor 900 and proceed with the final review of the translated episode (S318, see FIG. 3B).

On the basis of the final review of the translated episode having been completed, the translation server 110 and the management server 120 may generate a translated episode corresponding to the episode created based on the language of the first country by using the lettered file created based on the language of the second country (S319, see FIG. 3B).

As described above, the system 100 for operating content translation according to the present invention may provide content translation representatives with the necessary information and user environment for translation tasks, on the basis of interworking of the authority server 130, management server 120, and translation server 110. The representatives may easily proceed with content translation tasks using the task environment provided by the system 100 for operating content translation. Accordingly, the “system for operating content translation” according to the present invention may also be referred to as a “content translation platform” or a “content translation system.”

In addition, in order to provide the content translation representative with a user environment optimized for translation tasks, the present invention illustrates a new form of translation editor and review editor.

Hereinafter, a more detailed description will be provided on a translation support tool provided in the present invention and a method of translating content using the same.

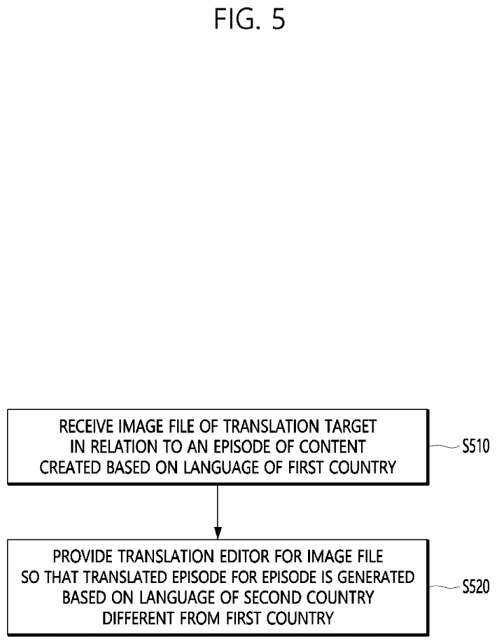

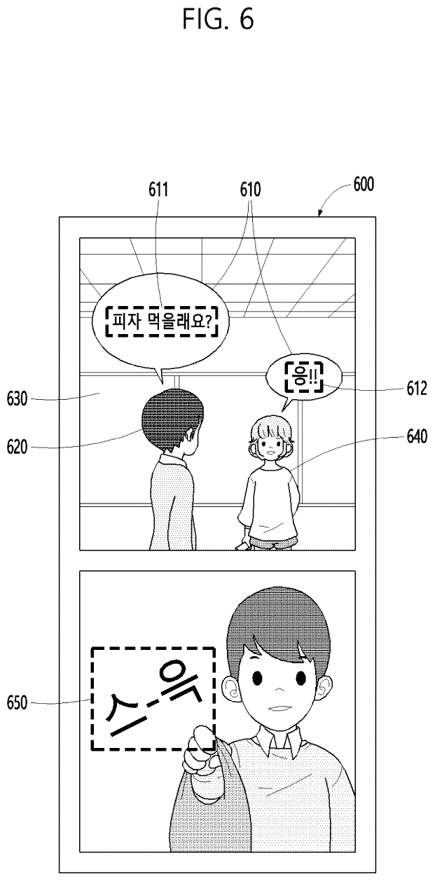

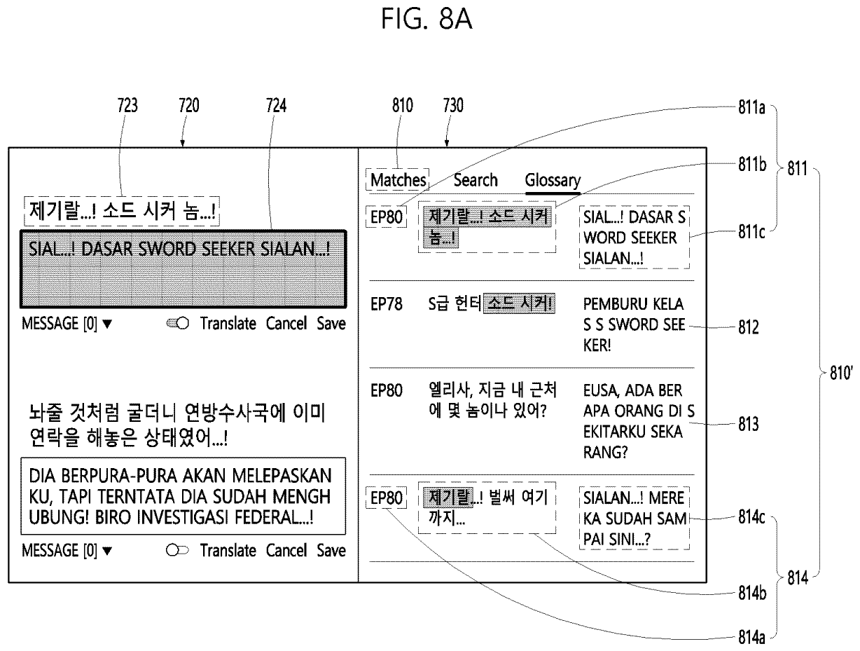

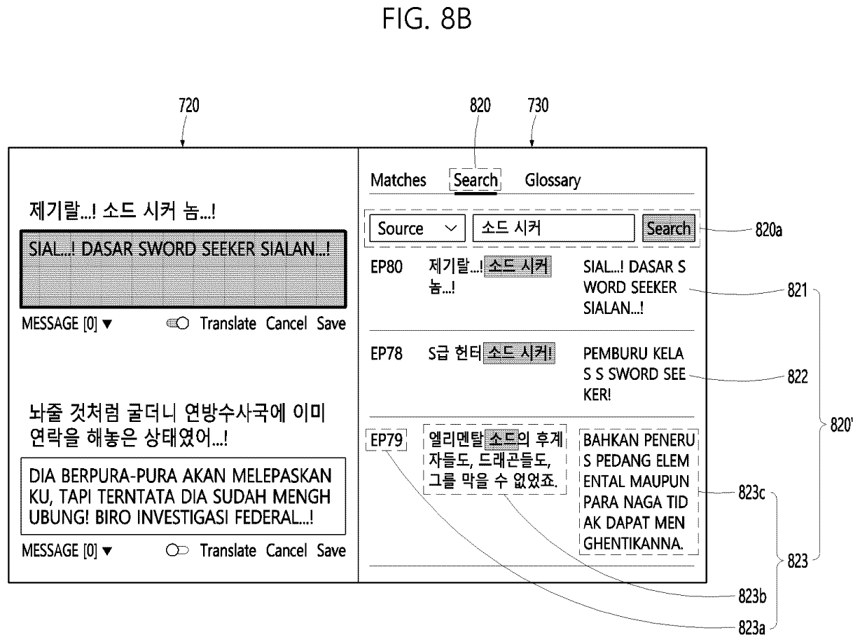

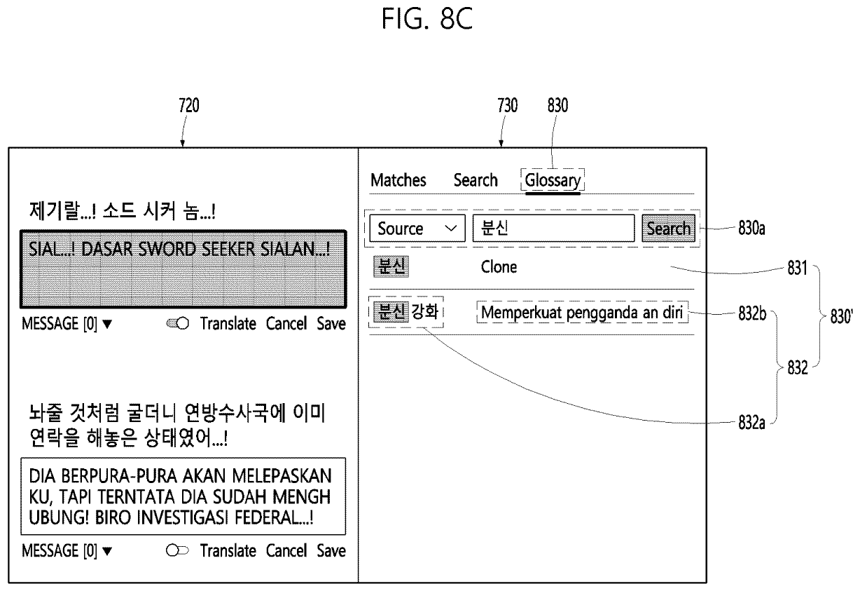

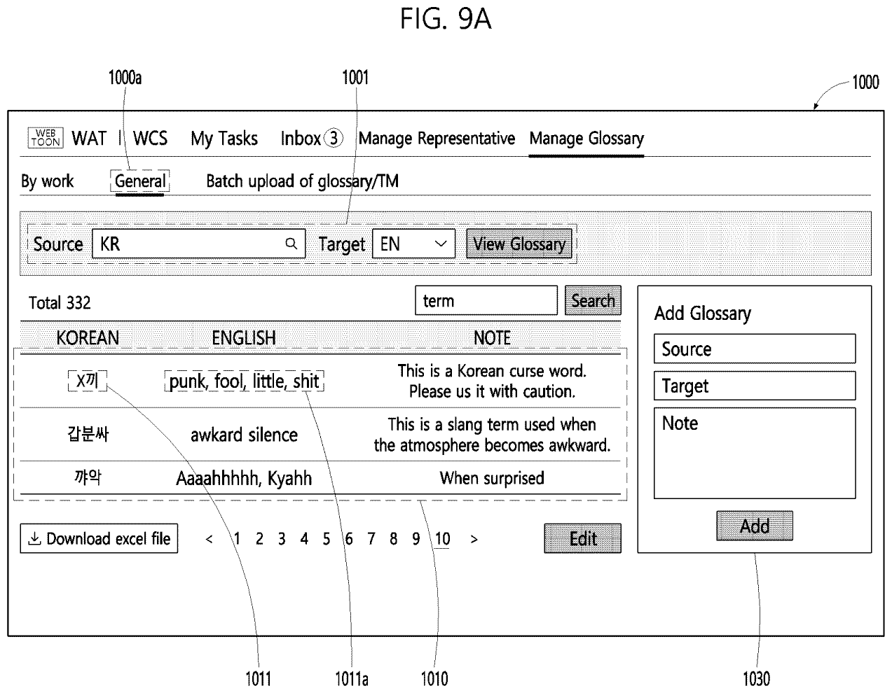

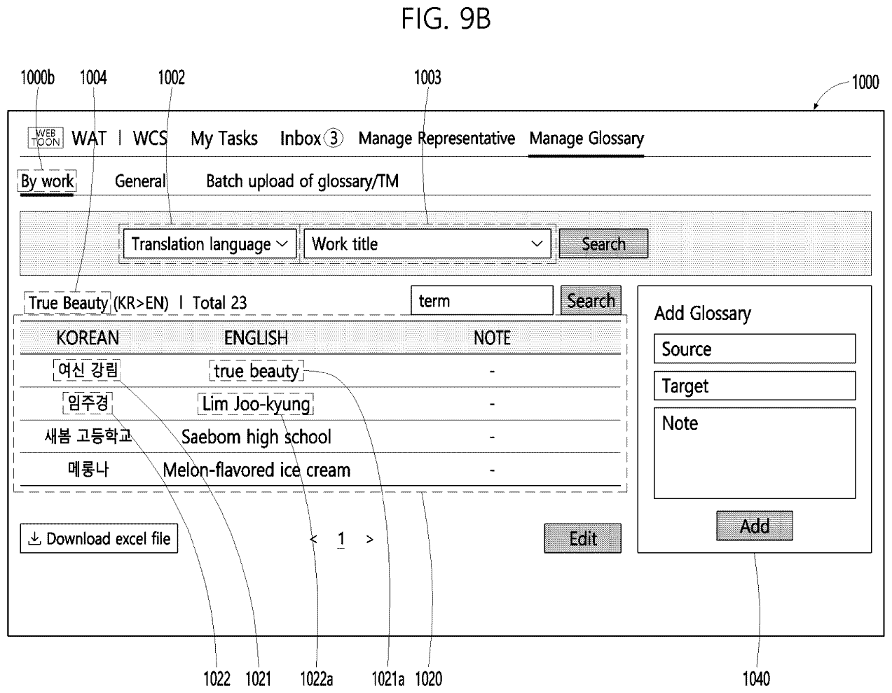

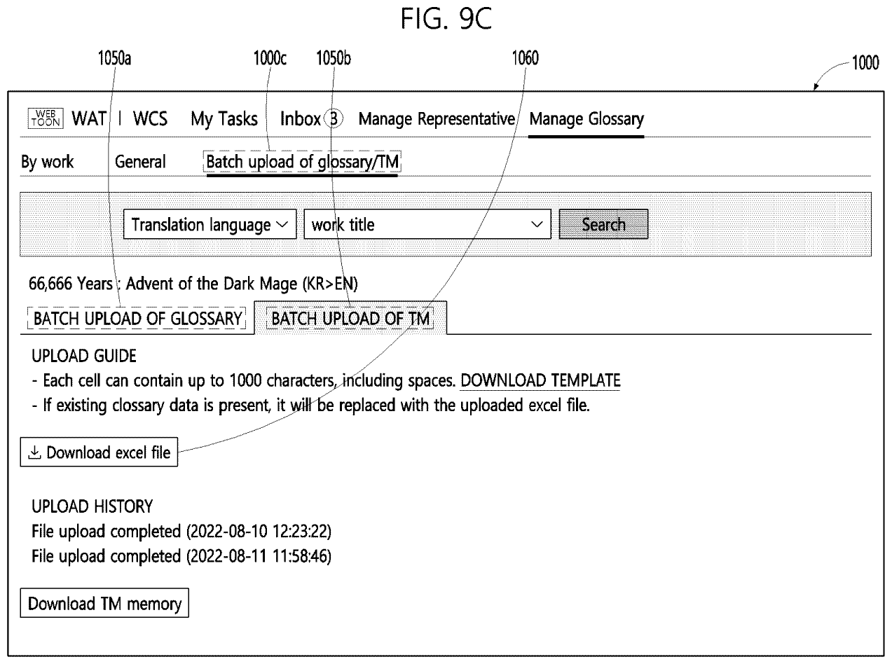

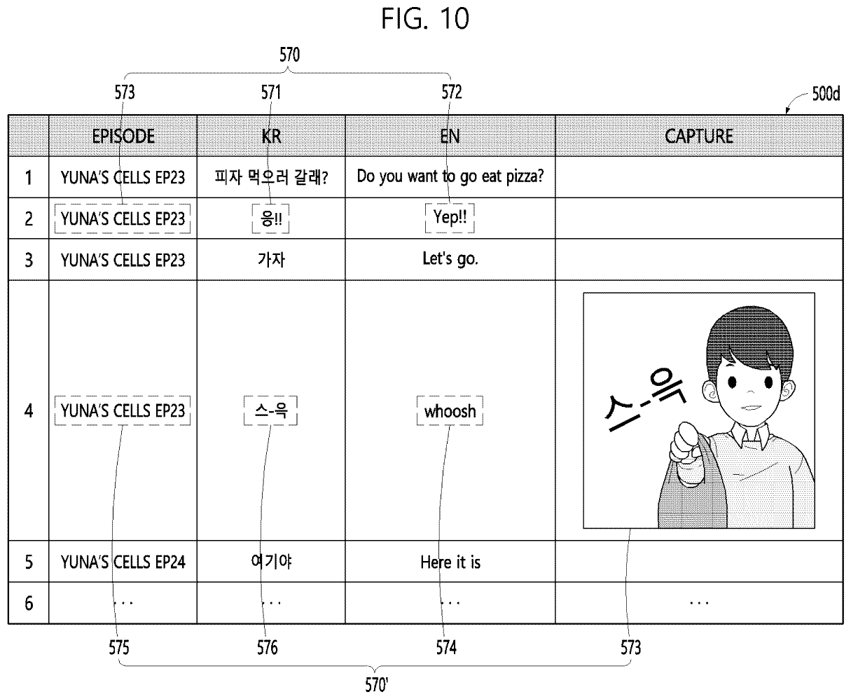

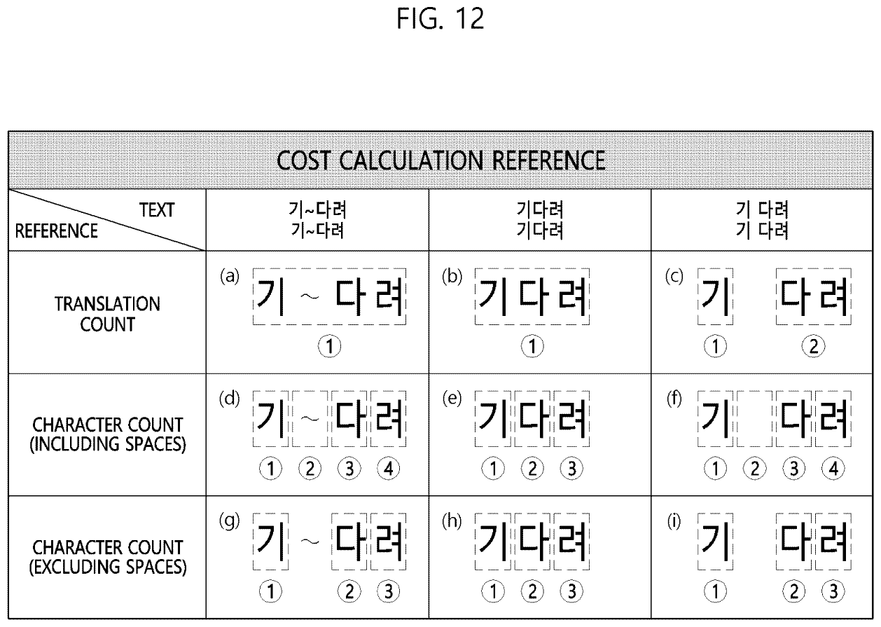

FIG. 5 is a flowchart for describing a method of translating content in the system 100 for performing content translation according to the present invention. FIG. 6 is a diagram for describing episodes of content, FIG. 7A and FIG. 7B are diagrams for describing a translation editor provided in the present invention, FIG. 8A, FIG. 8B, FIG. 8C, FIG. 9A, FIG. 9B, and FIG. 9C are diagrams for describing a translation support tool provided in the present invention, FIG. 10 is a diagram for describing a translation file according to the present invention, FIG. 11 is a diagram for describing a method of reviewing a lettered file, and FIG. 12 is a table illustrating a method of calculating the number of words to be translated according to the present invention.

In the present invention, with reference to an episode of content created based on the language of the first country, a process of receiving an image file of a translation target may proceed (S510, see FIG. 5).

The translation server 110 may receive an image file of an episode, which is a translation target, from the management server 120.

In the management server 120, episodes of specific content created based on the language of the first country (“source language,” “original work language,” or “translation target language”) may be registered and present. The management server 120 may register and manage the image files of episodes in a database, and provide the image files to the translation server 110 on the basis of being specified as translation targets.

In the present invention, a process of extracting text corresponding to the language of the first country from the image file may proceed.

The translation server 110 may use various algorithms trained to recognize and detect text (or characters) included in an image to extract at least one text included in the image file of a translation target episode.

For example, as illustrated in FIG. 6, the translation server 110 may, through an optical character reader (OCR), extract text (e.g., “ [symbol] ?”, “ [symbol] ”, 611, 612) corresponding to the language of the first country (e.g., “Korean”) from an image file 600 of a translation target episode.

The translation server 110, when extracting text included in the image file 600 of the translation target episode through the optical character reader (OCR), may also extract position information on the text.

Here, “position information on the text” may be understood as information regarding where the text is positioned within the image file 600 of the translation target episode. As such an example, coordinate information on the extracted text within the entire image of the episode may be stored as the position information.

The translation server 110 may extract the text 611 and 612 corresponding to the language of the first country and the position information on the text from the translation target episode image file 600 through the optical character reader (OCR). The text and the position information are matched with each other by the translation server 110, and configured as a paired data set.

The translation server 110 may extract the text corresponding to preset criteria from the image file 600 of the translation target episode into the translation target language. In the present invention, the image file 600 of the translation target episode may include a plurality of graphic objects 610, 620, 630, 640. The translation server 110 may extract, as the translation target language, text 611 and 612 included in a specific graphic object (e.g., speech bubble graphic object, 610) among the plurality of graphic objects 610, 620, 630, 640 included in the image file 600 of the translation target episode, which corresponds to the preset criteria.

More specifically, the translation server 110 may primarily identify the speech bubble graphic object 610 within the image file 600 of the translation target episode, and then, secondarily, extract the text 611 and 612 included in the speech bubble graphic object 610, along with position information on the text, through the optical character reader (OCR). The translation server 110 may extract position information on text layers for the extracted text 611 and 612 from the image file 600 of the translation target episode. Hereinafter, for convenience of description, the image file of the translation target episode will be interchangeably described as the “translation target image file” or “translation target image.”

In the present invention, a process may proceed to provide a translation editor for the image file so that a translated episode of the episode is generated based on the language of the second country, which differs from the language of the first country (S520, see FIG. 5).

The translation server 110 may provide the translator terminal with a translation editor for the translation representative using an episode image file that is a translation target, along with text extracted from the image file and position information on the text.

As illustrated in FIG. 7A, the translation editor 700 may have a screen configured of a plurality of areas 710, 720, 730, each displaying different information. Among the plurality of areas, in the first area 710 the translation target image file 600 may be output, while in the second area 720, an input window 721 may be output for receiving a translated text of the text (e.g., “ [symbol] ?” 611) extracted from the translation target image file 600 as input. In this case, to allow the translation representative to intuitively recognize which text among the plurality of texts included in the translation target image file 600 is currently being worked on for translation, a specific text (e.g., “ [symbol] ?” 611′) may be output around the input window 721 that is matched to the specific text.

Further, in the third area 730, at least one translation support tool 730a may be output to support the translation task of the translation representative. The translation support tool 730a may include various functions to support the translation task. For example, the translation support tool 730a may include a glossary 830 (or dictionary, or translated language recommendation tool, etc.) that recommends translated language on the basis of a database of the languages of the first country and the second country.

In the present invention, the first area to the third area 710, 720, 730 of the translation editor 700 may be configured so that the translation representative of the translation editor 700, while identifying the translation target image file 600, may input the translated language and easily use the translation support tool 730a as needed. For example, the translation editor 700 may be configured so that the translation target image file 600 and the translation support tool 730a are output on both side of the input window 721, with the first area 710, the second area 720, and the third area 730 of the translation editor 700 being sequentially disposed along one direction (e.g., from direction A to direction B).

In the present invention, control of the translation editor 700 may be performed so that the translation support tool 730a operates, interworking with the first area 710 and the second area 720 of the translation editor. When an input selecting one of the texts extracted from the translation target image file 600 is received, a list recommending the translated language for the selected text may be output in the translation support tool 730a. Further, when one of the translated languages in the list is selected, the translated language may be input into the input window in response to the selection.

More specifically, when receiving an input selecting one of the texts output in the first area 710 of the translation editor 700, the translation server 110 may interwork with and control the first area 710 and the third area 730 so that a list recommending translated languages for the selected text is output in the third area 730.

As illustrated in diagram (a) of FIG. 7B, the translation target image file 600 may be output in the first area 710 of the translation editor 700. The translation server 110 may receive a user input selecting a specific text (e.g., “ [symbol] !!”, 612) among the plurality of texts included in the translation target image file 600 while the translation target image file 600 is being output in the first area 710.

As illustrated in diagram (b) of FIG. 7B, the translation server 110 may output a recommendation list (or glossary 731) including recommended translated languages, i.e., recommended translations for the specific text (e.g., “ [symbol] !!”, 612) in the third area 730 in response to the user input selecting the specific text.

The recommended translated languages included in the recommendation list 731 may correspond to at least one of a first type of recommended translated language, i.e., a first type of recommended translation 731a or a second type of recommended translation 731b, i.e., second type of recommended translation, on the basis of their relevance to specific content constituting the episode.

The first type of recommended translated language 731a may be specified on the basis of a first type of database (general DB) established with reference to a plurality of contents registered in the management server 120. The first type of recommended translated language 731a may include the same translated language “Yes” for the same text “ [symbol] ,” regardless of the translation target episode (or content).

The second type of recommended translated language 731b is specified on the basis of a second type of database (work-specific DB) established with reference to specific content (e.g., “Yuna's Cells”), and may include different translated languages (e.g., “Yep”) depending on the translation target episode (or content) even for the same text “ [symbol] ”.

The translation server 110 may control the input window so that the selected translated language is input in response to the selection when one of the translated languages in the recommendation list is selected. As illustrated in diagram (c) of FIG. 7B, the translation server 110 may receive a user input selecting one of the recommended translated languages (e.g., “Yep”, 731b) from the recommendation list 731 through the third area 730. The translation server 110 may allow the second area 720 and the third area 730 to be interworked so that the selected recommended translated language “Yep” is input into the input window 722 of the second area 720 in response to a user input selecting one of the recommended translated languages (“Yep”, 731b). In this case, the translation server 110 may control the input window 722, which is matched to the corresponding text (e.g., “ [symbol] ”, 612) of the recommended translated language 731b, so that the recommended translated language 731b is input. As described above, the translation target image file 600 includes a plurality of texts, and the second area 720 may include input windows matched to each of the plurality of texts. The recommended translated language (“Yep”, 731b) corresponds to a specific text (“ [symbol] !!”, 612) among the plurality of texts, and the translation server 110 may control the input window 722 matched to the specific text so that the recommended translated language (“Yep”, 731b) is automatically input simply by the recommended translated language for the specific text being selected.

As illustrated in diagram (b) of FIG. 7B, the translation server 110 may convert the specific text (“ [symbol] !!”, 612) into the corresponding translated text (“Yep!!”, 731b) of the recommended translated language 731b in response to the input of the recommended translated language 722b in the input window 722 matched to the specific text, and output the specific text in the first area 710.

In the present invention, a translation support tool having a plurality of translation support function tabs, which are switched by tab input, is implemented using data established based on different databases, such as translation memory or glossaries. Hereinafter, a more detailed description will be provided on the process of performing translation using this translation support tool.

As illustrated in FIG. 7A, the translation support tool 730a may be configured to have a plurality of translation support function tabs 810, 820, and 830, which interwork with data established based on different databases respectively, to recommend translated languages, i.e., recommended translations. Whether the translation support tool in the third area 730 is provided based on a particular database may vary depending on which of the plurality of translation support function tabs 810, 820, 830 is selected.

The translation support function tabs 810, 820, 830 are made up of tab icons that is selectable by the user through touch input or mouse input, and may be disposed sequentially in a row in the third area 730 of the translation editor 700. When a selection command is applied to the translation support function tabs 810, 820, and 830, a screen matched to the selected translation support function tab may be output in the third area 730.

More specifically, among the plurality of translation support function tabs 810, 820, and 830, a first function tab (e.g., “Matches”, 810) and a second function tab (e.g., “Search”, 820) may have a function of recommending translated languages, i.e., translations, for the text extracted from the translation target image file 600 using data of memory in which previously input translations are stored.

The “memory in which previously input translations are stored” described in the present invention refers to the memory in which an original text that has previously undergone a translation task and a translated text input for that original text are stored, and may be referred to as “translation memory (TM)”. The translation memory (TM) may include one or more non-transitory computer-readable storage media that may be read and/or accessed by one or more processors. The one or more computer-readable storage media may include volatile and/or non-volatile storage components such as optical, magnetic, organic, or other memory or disk storage devices.

Further, among the plurality of translation support function tabs 810, 820, and 830, the third function tab (“Glossary”, 830) may have a function of recommending translations for the text extracted from the translation target image file 600 using a terminology database established by collecting languages from different first and second countries. In the present invention, the terminology database may also be referred to as a “glossary.” The terminology database may be an organized collection of translations. Further, the terminology database may be stored on a file system, or hosted on computer clusters or a cloud storage.

The translation server 110 may provide the translation support tool on the basis of one of the translation memory or the terminology database when one of the plurality of translation support function tabs 810, 820, and 830 is selected in the third area 730.

Each of the plurality of translation support function tabs 810, 820, and 830 may be provided with a translation support tool that has a different function.

For example, the first function tab (“Matches”, 810) may be provided with a first translation support tool that presents different sentences including at least a portion of the text extracted from the translation target image file 600. The second function tab (e.g., “Search”, 820) may be provided with a second translation support tool for searching the data in the memory. Further, the third function tab (e.g., “Glossary”, 830) may be provided with a third translation support tool that recommends translated languages based on the glossary.

The translation server 110 may provide the first translation support tool that uses the translation memory in at least a portion of the third area 730, on the basis of the first function tab (e.g., “Matches”, 810) being selected among the plurality of translation support function tabs 810, 820, and 830.

As illustrated in FIG. 8A, the first translation support tool may include a list 810′ including at least one different sentence items 811 to 814 that matches one of the texts extracted from the translation target image file (e.g., “ [symbol] . . . !”, 723). The sentence items 811 to 814 may include reference texts (“ [symbol] . . . !”, “ [symbol] [symbol] . . . ”, 811b, 814b) that match the specific text 723, episode information (“EP80”, 811a, 814a) on the episode from which the reference texts were extracted, and the previously input translated language for the reference texts (“SIAL . . . ! DASAR SWORD SEEKER SIALAN.!”, “SIALAN . . . ! MEREKA SUDAH SAMPAL SINI . . . ?”, 811c, 814c).

The translation server 110 may specify one of the texts extracted from the translation target image file for which the translation task will be supported using the first translation support tool. In this case, the translation server 110 may specify and input one of the texts extracted from the translation target image file as a support target text for the first translation support tool on the basis of the user's selection, into the input window 724 of the second area 720. For example, the translation server 110 may specify and input the text matched to the input window 724 with text input functionality activated among the plurality of input windows provided in the second area 720 of the translation editor 700 (e.g., “ [symbol] . . . ! [symbol] . . . !”, 723) as the support target text for the first translation support tool.

The translation server 110 may specify the original text, which matches the specific text 723, as a reference text for the specific text 723 from the translation memory in order to provide the first translation support tool in the third area 730. As described above, the translation memory may refer to memory in which an original text that has undergone the previous translation task and the translated language input for the original text are stored. As such an example, the translation memory may include memory from the translation task performed using translation programs supported by other servers or memory from other works worked on using the translation editor 700 of the present invention.

The translation server 110 may compare the specific text 723 with the original texts stored in the translation memory and specify at least one original text matched to the specific text 723 as the reference text for the specific text 723.

The translation server 110 may specify at least one original text matched to the specific text 723 as the reference text for the specific text 723 on the basis of preset criteria. The translation server 110 may specify an original text including at least a portion of the specific text 723 as the reference text for the specific text 723. For example, the translation server 110 may specify not only a different sentence 811b that matches the specific text 723, “ [symbol] . . . !”, but also a different sentence (e.g., “ [symbol] . . . ” 814b) where a portion, “ [symbol] . . . !”, matches as the reference text for the specific text.

When the reference text is specified, the translation server 110 may provide the reference text 811b or 814b, the previously input translated language for the reference text 811c or 814c, and the episode information on the episode from which the reference text 811a or 814a was extracted, in the third area 730 as the first translation support tool.

Through the first translation support tool output in the third area 730, the translation representative may identify the previously input translated languages for different sentences that match the specific text 723. The translation representative may utilize the previously input translated languages for different sentences to proceed with the translation task for the specific text 723.

For example, the translation representative may select at least one of different sentence items 811 to 814 output in the third area 730. The translation server 110 may interwork with the selection to input the previously input reference translated language corresponding to the selected item into the input window 724 for the specific text. The translation representative may modify the reference translated language input in the input window 724 for the specific text to quickly and consistently proceed with the translation task for the specific text.

According to one aspect of the present invention, the translation server 110 may provide the second translation support tool that uses the translation memory in at least a portion of the third area 730, on the basis of the second function tab (e.g., “Search”, 820) being selected among the plurality of translation support function tabs 810, 820, and 830.

As illustrated in FIG. 8B, the second translation support tool may provide a function for searching the data in the translation memory. In response to the second function tab 820 being selected, the translation server 110 may provide a search area 820a in at least a portion of the third area 730 of the translation editor, allowing the user to search for search words (or keywords or text). On the basis of a search word (e.g., “ [symbol] ”) being input through the search area 820a, the translation server 110 may provide a list 820′ in the third area 730, which includes at least one different sentence item 821 to 823 corresponding to the search word (e.g., “ [symbol] ”).

The sentence items 821 to 822 may include a reference text (e.g., “ [symbol] [symbol] [symbol] [symbol] ”, 823b) that includes at least a portion of the search word (e.g., “ [symbol] ”), episode information (“ep79”, 823a) on the episode from which the reference text was extracted, and the previously input translated language for the reference text (e.g., “BAHKAN PENERUS PEDANG ELEMENTAL MAUPUNPARA NAGA TIDAK DAPAT MENGHENTIKANNA”, 823c).

The translation server 110 may specify the original text corresponding to the search word (e.g., “ [symbol] ”) from the translation memory as the reference text for the search word (e.g., “ [symbol] ”). In this case, the translation server 110 may specify the original text corresponding to the search word (e.g., “ [symbol] ”) and the preset criteria as the reference text.

For example, the translation server 110 may specify an original text 823b that includes at least a portion (e.g., “ [symbol] ”) of the search word (e.g., “ [symbol] ”) as the reference text. Further, the translation server 110 may provide a reference text, the previously input translated language for the reference text, and the episode number information on the episode from which the reference text was extracted as search results for the search word in the third area 730.

The translation representative may use the search results output in the third area 730 to identify and refer to the previously input translated language in the translation task for the texts included in the translation target image file 600.

The translation server 110 may provide the third translation support tool that uses the terminology database in at least a portion of the third area 730, on the basis of the third function tab (e.g., “Glossary”, 830) being selected among the plurality of translation support function tabs 810, 820, and 830.

As illustrated in FIG. 8C, the third translation support tool may include a list 830′ including at least one different word or different sentence item 831 to 832 that matches one (e.g., “ [symbol] ”) of the texts extracted from the translation target image file. The different word or different sentence item 832 may include a reference text (“ [symbol] ”, 832a) that matches the specific text (“ [symbol] ”) and a recommended translated language (“Memperkuat penggnada an diri”, 832b) for the reference text.

The translation server 110 may specify one of the texts extracted from the translation target image file, which is a target for providing a recommended translated language based on the terminology database. For example, the translation server 110 may specify a specific text as a target for providing a recommended translated language on the basis of a text image corresponding to the specific text being selected in the first area 710 where the translation target image file 600 is output.

As another example, the translation server 110 may provide a search area 830a in at least a portion of the third area 730 in response to the third function support tab 830 being selected. Further, the translation server 110 may specify a search word (e.g., “ [symbol] ”) received through the search area 830a as a text for which a recommended translated language will be provided, on the basis of the terminology database.

As another example, the translation server 110 may, when one of the plurality of input windows displayed in the second area 720 is selected, specify a text matched to the selected input window as a text for which a recommended translated language will be provided, on the basis of the terminology database.

The translation server 110 may recommend a translated language corresponding to the second country for a specific text corresponding to the first country using a terminology database established by collecting languages of the first and second countries. In this case, the translation server 110 may recommend a translated language for the specific text using at least one of a first terminology database or a second terminology database, which are established to recommend translated languages for the specific text on the basis of different criteria.

The terminology database described in the present invention may include the first terminology database that recommends translated languages in language units of the first and second countries, and a second terminology database that recommends translated languages in a work unit of content.

In the present invention, the first terminology database may be understood as a terminology database that can be used to recommend translated languages for all content (or episodes) in the process of mutually translating between the language of the first country and the language of the second country.

For example, as illustrated in FIG. 9A, for a specific text 1011 included in the first content (e.g., “True Beauty”) and the second content (e.g., “Yuna's Cells”), the translation server 110 may commonly recommend a translation 1011a matched to the specific text on the basis of a first terminology database 1010.

The translation server 110 may manage the first terminology database (e.g., general glossary) in language units. As illustrated in FIG. 9A, the translation server 110 may output the first terminology database 1010 on the basis of a menu (e.g., “General”, 1000a) matched to the first terminology database being selected on a management page 1000.

In this case, the translation server 110 may provide the first terminology database 1010 on the basis of the first language (source language or original language) and the second language (target language) being specified through a language setting area 1001 of the management page, using the first and second languages as the basis. Further, the translation server 110 may perform terminology management, such as adding, modifying, and deleting terms, in language units of the first country and the second country.

The second terminology database may be understood as a terminology database that can be used to recommend translated languages for specific content, and as a “work-specific glossary.”

For example, as illustrated in FIG. 9B, a second terminology database 1020 may be established and exist based on specific content (e.g., “True Beauty”, 1004). In the translation process for specific content, a recommended translation for a text may be provided on the basis of the second terminology database 1020, which is established on the specific content basis.

More specifically, the second terminology database 1020, which is established on the first content (e.g., “True Beauty”) basis, may be used to recommend translated languages for the text included in the first content, and limited to be used to recommend translated languages for the second content (e.g., “Yuna's Cells”) different from the first content.

The translation server 110 may manage the second terminology database (e.g., work-specific glossary) in language and work units. As illustrated in FIG. 9B, the translation server 110 may output the second terminology database 1020 on the basis of a menu (e.g., “By Work”, 1000b) matched to the second terminology database being selected on the management page 1000.

In this case, the translation server 110 may provide the second terminology database 1020 for specific content 1004 on the basis of the language (first language and second language) and content being specified through a language setting area 1002 and a work setting area 1003 of the management page. Further, the translation server 110 may perform terminology management, such as adding, modifying, and deleting terms, in language units. Particularly, the translation server 110 may register texts that are frequently used in specific content or are used only in specific content, along with their corresponding translated languages, in the second terminology database.

In one embodiment of the present invention, at least one of the translation memory or terminology database may be batch uploaded, and the translation server 110 may interwork the batch-uploaded translation memory or terminology data with at least some of the plurality of translation support function tabs 810, 820, and 830. In the present invention, batch upload may be understood as deleting and replacing (or overwriting) previously uploaded data with new data.

As illustrated in FIG. 9C, the translation server 110 may provide a batch upload function for at least one of the translation memory or terminology database on the basis of a batch upload menu (e.g., “Batch Upload of Glossary/TM”, 1000c) being selected on the management page 1000. The translation server 110 may receive data in the translation memory from the management page 1000 on the basis of a translation memory batch upload tab (e.g., “TM Batch Upload”, 1050b) being selected. For example, the translation server 110 may receive data in the translation memory of a specific type of file (e.g., Excel) through the management page 1000 when an upload icon 1060 is selected.

The translation server 110 may receive data in the translation memory and interwork the data with each of the first function tab (e.g., “Matches”, 810) and the second function tab (e.g., “Search”, 820) among the plurality of translation support function tabs 810, 820, and 830.

Further, the translation server 110 may interwork the terminology database with the third function tab (e.g., “Glossary”, 830) among the plurality of translation support function tabs 810, 820, and 830. As described above, the terminology database may include the first terminology database that recommends translated languages in language units of the first and second countries, and a second terminology database that recommends translated languages in a work unit of content. The translation server 110 may batch upload the first terminology database and the second terminology database to interwork with the third function tab, ensuring that recommendations for the translated language are made based on at least one of the language or the work.

As illustrated in FIG. 9C, the translation server 110 may provide a batch upload function for at least one of the translation memory or terminology database on the basis of a batch upload menu (e.g., “Batch Upload of Glossary/TM”, 1000c) being selected on the management page 1000. The translation server 110 may perform a batch upload for the first terminology database and the second terminology database from the management page 1000 on the basis of a glossary batch upload tab 1050a being selected. In this case, the batch upload for the first terminology database and the second terminology database may be performed with a specific type of file (e.g., Excel).

The translation server 110 may generate a translation file on the basis of the information received from at least one of the translator terminal 210 or the reviewer terminal 230. Hereinafter, for convenience of description, an example will be provided where a translation file is generated on the basis of the information received from the translator terminal 210. However, when the information (translated language and original language) received from the translator terminal 210 has been updated on the basis of the information received from the reviewer terminal 230, the translation server 110 may generate a translation file using the updated information.

The translation server 110 may receive the translated language for the text extracted from the translation target image file 600 from the translator terminal 210. In addition, the translation server 110 may receive the original language and the translated language for the captured image 660 from the translation target image file 600, from the translator terminal.

The translation server 110 may generate a translation file for the translation target image file 600 using the extracted texts 611 and 612, the translated language for the language of the second country for the extracted texts, and the translated language and original language for the captured image 660.

In the present invention, the “translation file” may refer to a file provided to the lettering design representative responsible for a lettering task of the translated language. In this case, lettering may refer to replacing characters in the image file with characters in another language.

As illustrated in FIG. 10, the translation server 110 may generate a translation file 500d that includes a data set 570 for extracted text (e.g., “ [symbol] ”, 571) and a data set 570′ for a captured image 573. The translation server 110 may generate the data set 570 for the extracted text by matching at least some of the language of the first country (e.g., “ [symbol] !!”, 571), the translated language corresponding to the language of the first country (e.g., “Yep!!”, 572), information on the episode of the content from which the language of the first country was extracted (e.g., “Yuna's Cells Episode 23”, 575), or position information on the extracted language within the episode. Further, the translation server 110 may configure the data set 570′ for the captured image by matching at least some of the captured image 573, the translated language for the captured image (e.g., “whoosh”, 574), the original language for the captured image (“ [symbol] ”, 576), episode information corresponding to the captured image (e.g., “Yuna's Cells Episode 23”, 575), or position information on the captured image.

The translation server 110 may generate the translation file 500d using the data set 570 for the extracted text and the data set 570′ for the captured image 573.

The translation server 110 may generate the translation file as at least one of a first type of file or a third type of file.

The lettering designer needs to input (create, design, or sketch) the translated language in an area where the language of the first country was positioned, and it is important for the lettering designer to intuitively recognize matching relationship between the language of the first country and the language of the second country, which is the translated language. Accordingly, in the present invention, the translation file may be generated as a third type of file having a table structure and provided to the lettering designer.

In the lettering designer terminal 220, a task may be performed to change the language characters of the first language included in the character layer, among the plurality of layers that make up the translation target image file, into the translated language, which is the language of the second country, on the basis of the translation file. The lettering designer terminal 220 may generate a translated episode file (a lettered file or lettered image file) that is translated into the language of the second country, and the translation server 110 may receive the translated episode file (or lettered file) from the lettering designer terminal 220.

The translation server 110 may provide a final review editor to a final review representative terminal so that a final review of the translated episode file (lettered file or lettered image file) may be performed. In the present invention, the final review is referred to as “(lettered) image review,” “lettered file review,” “QA review,” or the like. Hereinafter, to avoid confusion of terms, the final review will be referred to as “QA review.” However, it is apparent that the QA review may alternatively be referred to as “image review,” “lettered file review,” “final review,” or the like.

As illustrated in FIG. 11, the translation server 110 may provide a QA editor 900 to a QA representative terminal so that a review of the translated episode that is translated into the language of the second language may be performed. In a first area 910 of the QA editor 900, the lettered image file (lettered translated episode, 911) may be output, while in a second area 920 of the QA editor 900, a translation target image file (or translation target manuscript, 921) may be output. That is, the translation server 110 may output the translated episode, lettered in the language of the second country, in the first area 910 of the QA editor 900, and output the original episode, created on the basis of the language of the first country, in the second area 920 of the QA editor 900.

The QA representative may proceed with a final review by comparing the lettered translated episode with the original episode regarding whether the translation has been performed accurately and whether the lettering of the translated language has been done correctly. The QA representative may, on the basis of the results of the QA review, generate a review list in a third area 930 of the QA editor 900.

The translation server 110 may receive a control command for image capture of at least a portion of the lettered image file 911 output in the first area 910 of the QA editor 900. The translation server 110 may, in response to the control command for image capture, generate an input window (“message input window” or “feedback input window,” 932) in the third area 930 to allow inputting a feedback message for the captured image 931. Further, the translation server 110 may display the captured image 931 around the message input window 932.

As described above, a QA reviewer may capture a portion of the lettered image file 911 within the QA editor 900 that requires modification, and transmit a feedback message for the captured image 931 to at least one of the translation representative or the lettering designer. In this case, the review representative may use the translation support tool 930a provided in the third area 930 of the QA editor 900. Since the translation support tool 930a is the same as the translation editor, a detailed description will be omitted. The method and the system for operating content translation according to the present invention provides a new form of translation editor and review editor, thereby implementing a translation environment in which translators, reviewers, and others can perform translations more accurately and efficiently.

According to another embodiment of the present invention, the number of words in the language to be translated included in the translation file may be calculated. The number of words calculated in the present invention may be matched to the content and stored in the management server 120.

The translation server 110 may count the number of words in the language to be translated included in the translation file to calculate the number of words of the language to be translated. The translation server 110 may calculate the number of words of the language to be translated on the basis of a translation target episode or content constituting the translation target episode and transmit the calculated number of words to the management server 120, matched with the content. The management server 120 may use the number of words of the language to be translated, matched with the content, for various translation tasks. For example, the management server 120 may calculate the costs of the translation task on the basis of the number of words of the language to be translated.

The translation server 110 may count the number of words of the language to be translated on various criteria basis. The translation server 110 may calculate the number of words of the language to be translated on the basis of one of i) a first calculation method (word count method), which counts the number of words on a spacing basis in an original text, ii) a second calculation method (character count method including spaces), which counts the number of characters including spaces and special characters, or iii) a third calculation method (character count method excluding spaces), which counts only the number of characters, excluding spaces and special characters.

The translation server 110 may produce different word count results depending on the criteria used to calculate the number of words.

The first calculation method (word count method) is a method of counting the number of words on a spacing basis in an original text, in which case, spaces and special characters are not counted. When counting the number of words of the language to be translated using the first calculation method (word count method), both “ [symbol] ” and “ [symbol] ” are counted as a single word (see Blocks (a) and (b) of FIG. 12). Further, “ [symbol] ” is counted as two words (see Block (c) of FIG. 12).

The second calculation method (character count method including spaces) is a method of counting the number of characters, including spaces and special characters in an original text. With this method, “ [symbol] ” is counted as 4 characters (see Block (d) of FIG. 12), “ [symbol] ” is counted as 3 characters (see Block (e) of FIG. 12), and “ [symbol] ” is counted as 4 characters (see Block (f) of FIG. 12).

The third calculation method (character count method excluding spaces) is a method of counting only the number of characters in an original text, excluding spaces and special characters. With this method, “ [symbol] ” is counted as 3 characters (see Block (g) of FIG. 12), while both “ [symbol] ” and “ [symbol] ” are also counted as 3 characters (see Blocks (h) and (i) of FIG. 12).

The translation server 110 may calculate the number of words of the language to be translated on the basis of an occasion when a task state of a translation target episode is one of a plurality of task states (e.g., a state switched to service). The translation server 110 may maintain the previously calculated number of words of the language to be translated without any change, even if the task state of the translation target episode changes after the number of words has been calculated. For example, even if the translation representative at an occasion when the number of words of the language to be translated was calculated was A, but later the translation representative changed to B, the translation server 110 may maintain the number of words of the language to be translated for the representative A on the basis of the occasion when the number of words of the language to be translated was calculated.

The method and system for operating content translation according to the present invention provides a new form of translation editor and a review editor, thereby implementing a translation environment in which translators, reviewers, and others can perform translations more accurately and efficiently.

Further, the method and the system for operating content translation according to the present invention can receive an image file of a translation target related to an episode of content created on the basis of the language of a first country, and provide a translation editor for the image file so that a translated episode based on the language of a second country different from the first country is generated.

The translation representative is provided with an efficient translation environment optimized for translation by the system, and the system may receive the translation results from the translation representative, translating from the language of the first country to the language of the second country.

Further, in the method and the system for translating content according to the present invention, the translation editor may provide an input window for receiving the translated language in the language of the second country for the image file as input. The translation representative may proceed with the translation task using a single translation editor without needing to switch between multiple programs.

Further, the method and the system for translating content according to the present invention may provide a translation support tool that has a plurality of translation support function tabs, each interworking with data established based on different databases to recommend the translated language. The translation representative can conveniently access the information needed for the translation task and translate more quickly and accurately using the translation support tool.

The computer-readable medium includes all kinds of storage devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

It should be appreciated that the detailed description is interpreted as being illustrative in every sense, not restrictive. The scope of the present invention should be determined on the basis of the reasonable interpretation of the appended claims, and all of the modifications within the equivalent scope of the present invention belong to the scope of the present invention.

What is claimed is:

1. A method of translating content performed by a computer system, comprising:
receiving an image file of a translation target related to an episode of content created based on a language of a first country; and
providing a translation editor for the image file so that a translated episode of the episode based on a language of a second country, different from the first country, is generated,
wherein the translation editor provides an input window for receiving a translated language in the language of the second country for the image file as input, and a translation support tool having a plurality of translation support function tabs that recommend the translated language, each interworking with data established based on different databases.

2. The method of claim 1, wherein the translation support function tabs include a first function tab and a second function tab, which recommend the translated language using data in memory that stores previously input translated languages, and
wherein one of the first function tab or the second function tab presents sentences including texts extracted from the image file, and the other thereof provides a function for searching the data in the memory.

3. The method of claim 2, further comprising:
receiving the data in the memory to interwork the data with the first function tab and the second function tab, respectively.

4. The method of claim 1, wherein the translation support function tabs include a third function tab that recommends the translated language using a terminology database established by collecting the languages of the first country and the second country.

5. The method of claim 4, wherein the terminology database includes a first terminology database that recommends the translated language in language units of the first and second countries, and a second terminology database that recommends the translated language in work units of the content.

6. The method of claim 5, further comprising:
batch uploading the first terminology database and the second terminology database to interwork the first terminology database and the second terminology with the third function tab.

7. The method of claim 1, wherein, upon receiving an input selecting one of texts extracted from the image file, a list recommending translated languages for the selected text is output in the translation support tool.

8. The method of claim 7, wherein, upon selecting one of the translated languages from the list, the selected translated language is input into the input window in response to the selection.

9. The method of claim 1, further comprising:
generating a translation file for the image file using the input translated language and calculating the number of words of a language to be translated included in the translation file.

10. The method of claim 9, wherein the image file is transmitted from a management server to a translation server that provides the translation editor, and the calculated number of words is matched with the content and stored in the management server.

11. The method of claim 1, wherein episode information on the episode interworks between a translation server providing the translation editor and a management server transmitting the image file to the translation server.

12. A system for translating content, comprising:
a management server configured to register an image file of a translation target for an episode of content created based on a language of a first country; and
a translation server configured to receive the image file of the translation target,
wherein the translation server provides a translation editor for the image file so that a translated episode of the episode based on a language of a second country, different from the first country, is generated, and
wherein the translation editor provides an input window for receiving a translated language in the language of the second country for the image file as input, and a translation support tool having a plurality of translation support function tabs that recommend the translated language, each interworking with data established based on different databases.

13. The system of claim 12, wherein the translation support function tabs include a first function tab and a second function tab, which recommend the translated language using data in memory that stores previously input translated languages, and
wherein one of the first function tab or the second function tab presents sentences including texts extracted from the image file, and the other thereof provides a function for searching the data in the memory.

14. A non-transitory computer-readable recording medium storing a program for enable a computer system to execute the steps comprising:
receiving an image file of a translation target related to an episode of content created based on a language of a first country; and
providing a translation editor for the image file so that a translated episode of the episode based on a language of a second country, different from the first country, is generated,
wherein the translation editor provides an input window for receiving a translated language in the language of the second country for the image file as input, and a translation support tool having a plurality of translation support function tabs that recommend the translated language, each interworking with data established based on different databases.
